(19) United States
(12) Patent Application Publication
(10) Pub. No.: US 2023/0317109 A1
(43) Pub. Date: Oct. 5, 2023

(54) MAGNETIC RECORDING MEDIUM AND CARTRIDGE

(71) Applicant: Sony Group Corporation, Tokyo (JP)

(72) Inventor: Hiroshi KAWAI, Tokyo (JP)

(21) Appl. No.: 18/015,252

(22) PCT Filed: Jul. 14, 2021
(86) PCT No.: PCT/JP2021/026485

§ 371 Date: Jan. 9, 2023

(30) Foreign Application Priority Data
Jul. 14, 2020 (JP) 2020-120898

(51) Int. Cl. G11B 5/706; G11B 5/714; G11B 5/735; G11B 5/592; G11B 23/027

(52) U.S. Cl. CPC G11B 5/70678; G11B 5/714; G11B 5/7356; G11B 5/5928; G11B 23/027

(57) ABSTRACT

Provided is a magnetic recording medium capable of suppressing deterioration of running stability even after repeated recording or reproduction is performed.

The magnetic recording medium is a magnetic recording medium having a tape shape, and includes a substrate, an underlayer provided on one surface of the substrate and including a magnetic powder and a binder, and a magnetic layer provided on the underlayer and including a nonmagnetic powder and a binder. The magnetic recording medium has an average thickness of 5.3 μm or less. In a case where a correlation between an amount of projected particles and an erosion depth is obtained in each of the underlayer and the magnetic layer by a micro slurry-jet erosion (MSE), a calculation of a ratio of a particle amount required to wear an erosion depth range to the erosion depth range is performed in each of the underlayer and the magnetic layer on the basis of the correlation, and a result of the calculation is defined as an MSE resistance value of each of the underlayer and the magnetic layer, the ratio of the MSE resistance value of the magnetic layer to the MSE resistance value of the underlayer is in a range of 0.45 or more and 0.80 or less.

### TECHNICAL FIELD

The present disclosure relates to a magnetic recording medium and a cartridge including the magnetic recording medium.

### BACKGROUND ART

A magnetic recording medium that includes an underlayer including magnetic powder and a binder and a magnetic layer including nonmagnetic powder and a binder is widely used for storing electronic data. As for the magnetic recording medium described above, in order to improve running durability, a technology of adjusting the hardness of a surface of the magnetic layer has been studied.

For example, Patent Document 1 discloses that a magnetic recording medium excellent in running performance and electromagnetic conversion characteristics is obtained by controlling a plastic deformation amount and indentation hardness of an outermost surface of a magnetic layer.

Patent Document 2 discloses that in a magneto-resistive (MR) head recording-reproducing system, a magnetic recording medium with excellent durability is also obtained by specifying plastic deformation hardness of an outermost layer of the magnetic layer and Young's modulus in a thickness direction of the magnetic layer to a specific range.

### CITATION LIST

### Patent Document

Patent Document 1: Japanese Patent Application Laid-Open No. 2002-237024
Patent Document 2: Japanese Patent Application Laid-Open No. 2001-084547

### SUMMARY OF THE INVENTION

### Problems to be Solved by the Invention

However, in the conventional technology of adjusting the hardness of the surface of the magnetic layer, the running stability may be deteriorated after repeated recording or reproduction is performed.

An object of the present disclosure is to provide a magnetic recording medium capable of suppressing deterioration of running stability even after repeated recording or reproduction is performed and a cartridge including the magnetic recording medium.

### Solutions to Problems

In order to solve the above problem, a first disclosure is a magnetic recording medium having a tape shape, the magnetic recording medium including a substrate, an underlayer provided on one surface of the substrate and including a magnetic powder, a binder, and a lubricant, and a magnetic layer provided on the underlayer and including a nonmagnetic powder and a binder, in which the magnetic recording medium has an average thickness of 5.3 μm or less, and in a case where a correlation between an amount of projected particles and an erosion depth is obtained in each of the underlayer and the magnetic layer by a micro slurry-jet erosion (MSE) test, a calculation of a ratio of a particle amount required to wear an erosion depth range to the erosion depth range is performed in each of the underlayer and the magnetic layer on the basis of the correlation, and a result of the calculation is defined as an MSE resistance value of each of the underlayer and the magnetic layer, a ratio of the MSE resistance value of the magnetic layer to the MSE resistance value of the underlayer is in a range of 0.45 or more and 0.80 or less.

A second disclosure is a cartridge including the magnetic recording medium according to the first disclosure.

### BRIEF DESCRIPTION OF DRAWINGS

FIG. 1 is an exploded perspective view illustrating an example of a configuration of a cartridge according to one embodiment of the present disclosure.

FIG. 2 is a block diagram illustrating an example of a configuration of a cartridge memory.

FIG. 3 is a sectional view illustrating an example of a configuration of a magnetic tape.

FIG. 4 is a schematic diagram illustrating an example of a layout of a data band and a servo band.

FIG. 5 is an enlarged diagram illustrating an example of a configuration of the data band.

FIG. 6 is an enlarged diagram illustrating an example of a configuration of the servo band.

FIGS. 7A and 7B are views each illustrating an example of a TEM photograph of a magnetic layer.

FIG. 8 is a graph illustrating an example of a profile of erosion marks for N times.

FIG. 9 is a graph illustrating an example of a correlation between an amount of projected particles and an erosion depth.

FIGS. 10A and 10B are schematic diagrams for each describing a method of measuring a friction coefficient between a magnetic surface and a magnetic head.

FIG. 11 is an exploded perspective view illustrating an example of a configuration of a cartridge according to a modification of one embodiment of the present disclosure.

### MODE FOR CARRYING OUT THE INVENTION

An embodiment of the present disclosure will be described in the following order.
1. Configuration of cartridge
2. Configuration of cartridge memory
3. Configuration of magnetic tape
4. Method of manufacturing magnetic tape
5. Operation and effect
6. Modification

[1. Configuration of Cartridge]

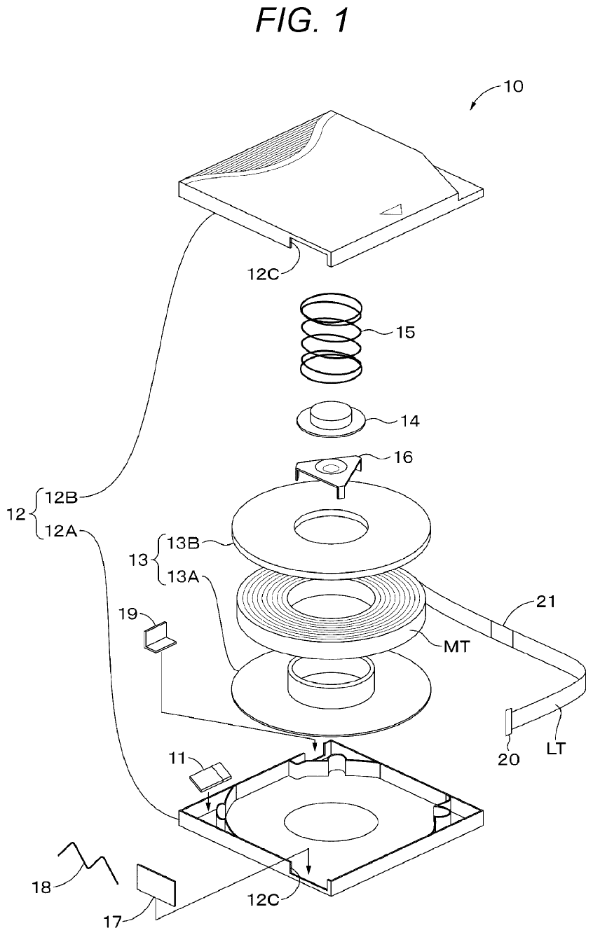

FIG. 1 is an exploded perspective view illustrating an example of a configuration of a cartridge 10. The cartridge 10 is a cartridge with one reel, and includes one reel 13 around which a tape-shaped magnetic recording medium (hereinafter, referred to as a “magnetic tape”) MT is wound inside a cartridge case 12 including a lower shell 12A and an upper shell 12B, a reel lock 14 and a reel spring 15 for locking rotation of the reel 13, a spider 16 for releasing a locked state of the reel 13, a slide door 17 for opening and closing a tape outlet 12C provided in the cartridge case 12 across the lower shell 12A and the upper shell 12B, a door spring 18 that biases the slide door 17 to a closed position of the tape outlet 12C, a write protect 19 for preventing erroneous erasure, and a cartridge memory 11. The reel 13 for winding the magnetic tape MT has a substantially disk shape having an opening in a central portion, and includes a reel hub 13A and a flange 13B including a hard material such as plastic. A leader tape LT is connected to one end on an outer periphery of the magnetic tape MT. A leader pin 20 is provided at a tip of the leader tape LT.

The cartridge 10 may be a magnetic tape cartridge compliant with a linear tape-open (LTO) standard, or may be a magnetic tape cartridge conforming to a standard different from the LTO standard.

The cartridge memory 11 is provided near one corner of the cartridge 10. In a state where the cartridge 10 is loaded into the recording-reproducing device, the cartridge memory 11 faces a reader-writer of the recording-reproducing device. The cartridge memory 11 communicates with a recording-reproducing device, specifically, the reader-writer by a wireless communication standard conforming to the LTO standard.

[2. Configuration of Cartridge Memory]

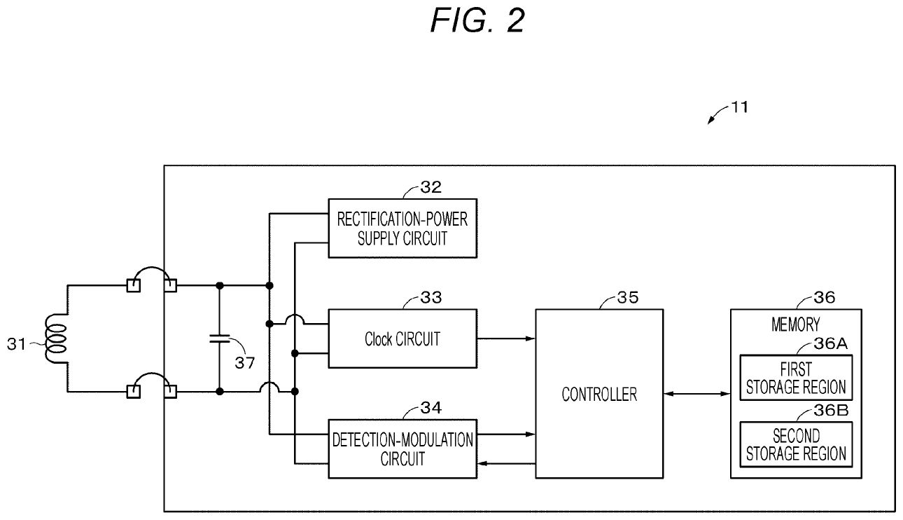

FIG. 2 is a block diagram illustrating an example of a configuration of the cartridge memory 11. The cartridge memory 11 includes an antenna coil (communication unit) 31 that communicates with the reader-writer by a prescribed communication standard, a rectification-power supply circuit 32 that generates power from a radio wave received by the antenna coil 31 by using an induced electromotive force and performs rectification to generate a power supply, a clock circuit 33 that generates a clock from the radio wave received by the antenna coil 31 by using the induced electromotive force similarly, a detection-modulation circuit 34 that detects the radio wave received by the antenna coil 31 and modulates a signal transmitted by the antenna coil 31, a controller (control unit) 35 including a logic circuit or the like that determines a command and data from a digital signal extracted from the detection-modulation circuit 34 and processes the command and data, and a memory (storage) 36 that stores information. In addition, the cartridge memory 11 includes a capacitor 37 connected in parallel to the antenna coil 31, and a resonance circuit is configured by the antenna coil 31 and the capacitor 37.

The memory 36 stores information and the like related to the cartridge 10. The memory 36 is a non volatile memory (NVM). A storage capacity of the memory 36 is preferably about 32 KB or more.

The memory 36 includes a first storage region 36A and a second storage region 36B. The first storage region 36A corresponds to, for example, a storage area of a cartridge memory of a magnetic tape standard before a specified generation (for example, an LTO standard before LTO 8), and is a region for storing information conforming to a magnetic tape standard before the prescribed generation (for example, an LTO standard before LTO 8). The information conforming to the magnetic tape standard before the specified generation (for example, the LTO standard before LTO 8) includes, for example, at least one of manufacturing information of the cartridge 10 (for example, a unique number of the cartridge 10 or the like), a use history of the cartridge (for example, a thread count of the magnetic tape MT or the like), or the like.

The second storage region 36B corresponds to an extended storage region for a storage region of a cartridge memory of a magnetic tape standard before a specified generation (for example, an LTO standard before LTO 8). The second storage region 36B is a region for storing additional information. Here, the additional information means, for example, information related to the cartridge 10 that is not defined in the magnetic tape standard before a specified generation earlier (for example, an LTO standard before the LTO 8). The additional information includes, for example, at least one of tension adjustment information, management ledger data, index information, thumbnail information, or the like.

The tension adjustment information is information for adjusting a tension applied to the magnetic tape MT in a longitudinal direction. The tension adjustment information includes a distance between adjacent servo bands (a distance between servo patterns recorded on adjacent servo bands) at a time of data recording on the magnetic tape MT. The distance between adjacent servo bands is an example of width-related information related to a width of the magnetic tape MT.

The management ledger data is data including at least one of a capacity, a creation date, an editing date, a storage location, or the like of a data file recorded on the magnetic tape MT. The index information is metadata or the like for searching the content of the data file. The thumbnail information is a thumbnail of a moving image or a still image stored on the magnetic tape MT. In the following description, the information stored in the first storage region 36A may be referred to as “first information”, and the information stored in the second storage region 36B may be referred to as “second information”.

The memory 36 may have a plurality of banks. In this case, some of the plurality of banks may constitute the first storage region 36A, and the remaining banks may constitute the second storage region 36B.

The antenna coil 31 induces an induced voltage by electromagnetic induction. The controller 35 communicates with the recording-reproducing device by a prescribed communication standard via the antenna coil 31. Specifically, for example, mutual authentication, command transmission and reception, data exchange, and the like are performed.

The controller 35 stores information received from the recording-reproducing device via the antenna coil 31 in the memory 36. For example, the tension adjustment information received from the recording-reproducing device via the antenna coil 31 is stored in the second storage region 36B of the memory 36. In response to a request from the recording-reproducing device, controller reads information from the memory 36, and transmits the information to the recording-reproducing device via the antenna coil 31. For example, in response to a request from the recording-reproducing device, the tension adjustment information is read from the second storage region 36B of the memory 36, and is transmitted to the recording-reproducing device via the antenna coil 31.

[3. Configuration of Magnetic Tape]

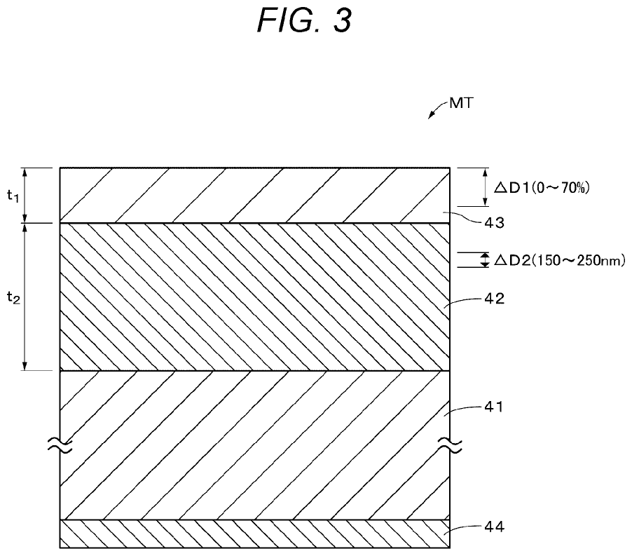

FIG. 3 is a sectional view illustrating an example of a configuration of the magnetic tape MT. The magnetic tape MT includes an elongated substrate 41, an underlayer 42 provided on one main surface (first main surface) of the substrate 41, a magnetic layer 43 provided on the underlayer 42, and a back layer 44 provided on the other main surface (second main surface) of the substrate 41. Note that the underlayer 42 and the back layer 44 are provided as necessary, and do not need to be provided. The magnetic tape MT may be a perpendicular recording type magnetic recording medium or a longitudinal recording type magnetic recording medium.

The magnetic tape MT may conform to the LTO standard, or may conform to a standard different from the LTO standard. The width of the magnetic tape MT may be ½ inches, or may be larger than ½ inches. In a case where the magnetic tape MT conforms to the LTO standard, the width of the magnetic tape MT is ½ inches. The magnetic tape MT may have a configuration in which the width of the magnetic tape MT can be kept constant or substantially constant by adjusting tension applied in the longitudinal direction of the magnetic tape MT during traveling by a recording-reproducing device (drive).

The magnetic tape MT has an elongated shape, and travels in the longitudinal direction during recording and reproduction. The magnetic tape MT is preferably used in a recording-reproducing device including a ring type head as a recording head. The magnetic tape MT is preferably used in a recording-reproducing device configured to be able to record data with a data track width of 1500 nm or less or 1000 nm or less.

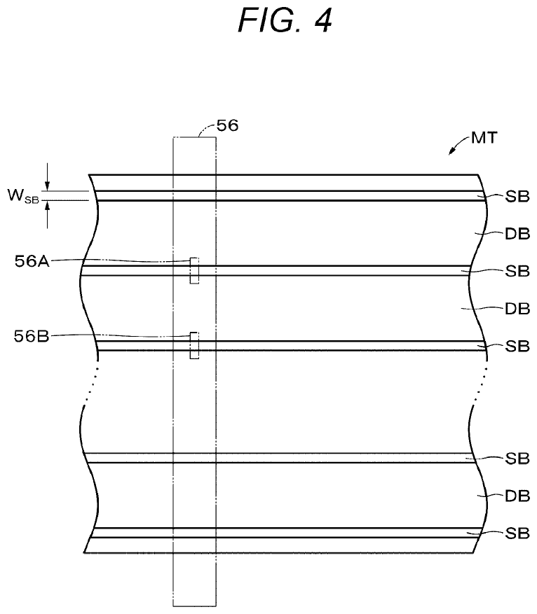

The magnetic tape MT is preferably reproduced by a reproducing head using a TMR element. A signal reproduced by the reproducing head using TMR may be data recorded in a data band DB (see FIG. 4) or a servo pattern (servo signal) recorded in a servo band SB (see FIG. 4).

(Substrate)

The substrate 41 is a nonmagnetic support that supports the underlayer 42 and the magnetic layer 43. The substrate 41 has an elongated film shape. An upper limit value of an average thickness of the substrate 41 is, for example, 4.4 μm or less, preferably 4.2 μm or less, more preferably 4.0 μm or less, still more preferably 3.8 μm or less, particularly preferably 3.6 μm or less, and most preferably 3.4 μm or less. When the upper limit value of the average thickness of the substrate 41 is 4.4 μm or less, a recording capacity for recording in one data cartridge can be increased as compared with a general magnetic tape. A lower limit value of the average thickness of the substrate 41 is preferably 3 μm or more, and more preferably 3.2 μm or more. When the lower limit value of the average thickness of the substrate 41 is 3 μm or more, a decrease in strength of the substrate 41 can be suppressed.

The average thickness of the substrate 41 is obtained as follows. First, the magnetic tape MT accommodated in the cartridge 10 is unwound, and the magnetic tape MT is cut to a length of 250 mm at a position of 30 m to 40 m in the longitudinal direction from a connection portion 21 between the magnetic tape MT and the leader tape LT to prepare a sample. In the present specification, the “longitudinal direction” in a case of the “longitudinal direction from the connection portion 21 between the magnetic tape MT and the leader tape LT” means a direction from one end on a side of the leader tape LT toward the other end on the opposite side.

Subsequently, layers other than the substrate 41 of the sample (that is, the underlayer 42, the magnetic layer 43, and the back layer 44) are removed with a solvent such as methyl ethyl ketone (MEK) or dilute hydrochloric acid. Next, a thickness of the sample (substrate 41) is measured at five positions by using Laser Hologauge (LGH-110C) manufactured by Mitutoyo Corporation as a measuring device, and measured values are simply averaged (arithmetic average) to calculate the average thickness of the substrate 41. Note that the five measurement positions described above are randomly selected from the sample so as to be different positions in the longitudinal direction of the magnetic tape MT.

The substrate 41 includes, for example, at least one of polyesters, polyolefins, cellulose derivatives, vinyl resins, or other polymer resins. In a case where the substrate 41 includes two or more of the materials described above, the two or more materials may be mixed, copolymerized, or laminated.

The substrate 41 preferably includes polyesters among the polymer resins described above. Since the substrate 41 includes polyesters, it is easy to particularly reduce Young's modulus of the substrate 41 in the longitudinal direction. Therefore, by adjusting the tension of the magnetic tape MT in the longitudinal direction during traveling by the recording-reproducing device, it is particularly easy to perform control to keep the width of the magnetic tape MT constant or substantially constant.

The polyesters include, for example, at least one of polyethylene terephthalate (PET), polyethylene naphthalate (PEN), polybutylene terephthalate (PBT), polybutylene naphthalate (PBN), polycyclohexylene dimethylene terephthalate (PCT), polyethylene-p-oxybenzoate (PEB), or polyethylene bisphenoxy carboxylate. In a case where the substrate 41 includes two or more polyesters, the two or more polyesters may be mixed, copolymerized, or laminated. At least one of a terminal or a side chain of the polyester may be modified.

The polyolefins include, for example, at least one of polyethylene (PE) or polypropylene (PP). The cellulose derivatives include, for example, at least one of cellulose diacetate, cellulose triacetate, cellulose acetate butyrate (CAB), or cellulose acetate propionate

(CAP). The vinyl resins include, for example, at least one of polyvinyl chloride (PVC) or polyvinylidene chloride (PVDC).

The other polymer resin includes, for example, at least one of polyamide (PA (nylon)), aromatic polyamide (aromatic PA (aramid)), polyimide (PI), aromatic polyimide (aromatic PI), polyamideimide (PAI), aromatic polyamideimide (aromatic PAI), polybenzoxazoles (PBO, for example Zylon (registered trademark)), polyether, polyether ketone (PEK), polyether ether ketone (PEEK), polyether ester, polyether sulfone (PES), PEI (polyether imide), polysulfone (PSF), polyphenylene sulfide (PPS), polycarbonate (PC), polyarylate (PAR), or polyurethane (PU).

The substrate 41 may be biaxially stretched in the longitudinal direction and a width direction. The polymer resin included in the substrate 41 is preferably oriented in an oblique direction with respect to the width direction of the substrate 41.

(Magnetic Layer)

The magnetic layer 43 is a recording layer for recording a signal by a magnetization pattern. The magnetic layer 43 may be a perpendicular recording type recording layer or a longitudinal recording type recording layer. The magnetic layer 43 includes, for example, magnetic powder, a binder, and a lubricant. The magnetic layer 43 may further include at least one additive of an antistatic agent, an abrading agent, a curing agent, a rust inhibitor, nonmagnetic reinforcing particles, or the like as necessary. The magnetic layer 43 may have a surface having an uneven shape.

As illustrated in FIG. 4, the magnetic layer 43 may have a plurality of servo bands SB and a plurality of data bands DB in advance. The plurality of servo bands SB is provided at equal intervals in the width direction of the magnetic tape MT. The data band DB is provided between the adjacent servo bands SB. The servo band SB is for guiding the magnetic head 56 (specifically, servo lead heads 56A and 56B) at a time of recording or reproducing data. In the servo band SB, a servo pattern (servo signal) for tracking control of the magnetic head is written in advance. User data is recorded in the data band DB.

An upper limit value of a ratio R_{S} (=(S_{SB}/S)×100) of a total area S_{SB} of the plurality of servo bands SB to an area S of the surface (hereinafter, appropriately referred to as a “magnetic surface”) of the magnetic layer 43 is preferably 4.0% or less, more preferably 3.0% or less, and still more preferably 2.0% or less in terms of securing a high recording capacity. On the other hand, a lower limit value of the ratio R_{S} of the total area S_{SB} of the plurality of servo bands SB to the area S of the surface of the magnetic layer 43 is preferably 0.8% or more in terms of securing five or more servo bands SB.

The ratio R_{S} of the total area S_{SB} of the plurality of servo bands SB to the area S of the entire surface of the magnetic layer 43 is obtained as follows. The magnetic tape MT is developed by using a ferricolloid developer (SigMarker Q manufactured by Sigma Hi-Chemical, Inc.), and then the developed magnetic tape MT is observed with an optical microscope to measure a servo band width W_{SB} and the number of servo bands SB. Next, the ratio R_{S} is obtained from the following equation.

Ratio R_{S}[%]=(((servo band width W_{SB})×(number of servo bands SB))/(width of magnetic tape MT))×100

The number of servo bands SB is, for example, 5+4n (where n is an integer of 0 or more) or more. The number of servo bands SB is preferably five or more, and more preferably nine or more. When the number of the servo bands SB is five or more, an influence on the servo signal due to a dimensional change of the magnetic tape MT in the width direction can be suppressed, and stable recording-reproducing characteristics with less off-track can be secured. An upper limit value of the number of servo bands SB is not limited, but is, for example, 33 or less.

The number of servo bands SB is obtained in a similar manner to a method of calculating the ratio R_{S} described above.

An upper limit value of the servo band width W_{SB} is preferably 95 μm or less, more preferably 60 μm or less, and still more preferably 30 μm or less in terms of securing a high recording capacity. A lower limit value of the servo band width W_{SB} is preferably 10 μm or more. It is difficult to manufacture a magnetic head capable of reading a servo signal having a servo band width W_{SB} of less than 10 μm.

A width of the servo band width W_{SB} is obtained in a similar manner to the method of calculating the ratio R_{S} described above.

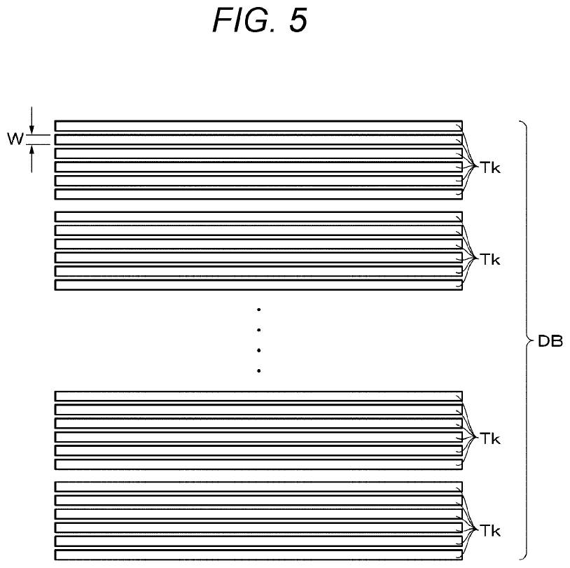

As illustrated in FIG. 5, the magnetic layer 43 is configured to be able to form a plurality of data tracks Tk in the data band DB. An upper limit value of a data track width W is preferably 2000 nm or less, more preferably 1500 nm or less, and still more preferably 1000 nm or less in terms of improving a track recording density and securing a high recording capacity. A lower limit value of the data track width W is preferably 20 nm or more in consideration of a magnetic particle size.

In terms of securing a high recording capacity, the magnetic layer 43 is configured to be capable of recording data such that a minimum value L of a magnetization reversal distance is preferably 40 nm or less, more preferably 36 nm or less, and still more preferably 32 nm or less. A lower limit value of the minimum value L of the magnetization reversal distance is preferably 20 nm or more in consideration of the magnetic particle size.

The magnetic layer 43 is configured to be capable of recording data such that the minimum value L of the magnetization reversal distance and the data track width W satisfy preferably W/L 35, more preferably W/L 30, and still more preferably W/L 25. When the minimum value L of the magnetization reversal distance is a constant value, and the minimum value L of the magnetization reversal distance and the track width W satisfy W/L>35 (that is, the track width W is larger), the track recording density is not increased, and thus, there is a possibility that the recording capacity cannot be sufficiently secured. In addition, when the track width W is a constant value and the minimum value L of the magnetization reversal distance and the track width W satisfy W/L>35 (that is, the minimum value L of the magnetization reversal distance is smaller), a bit length decreases and a linear recording density increases, but there is a possibility that electromagnetic conversion characteristics are significantly deteriorated due to an influence of spacing loss. Therefore, in order to suppress deterioration of electromagnetic conversion characteristics while securing the recording capacity, it is preferable that W/L is in a range of W/L≤35 as described above. A lower limit value of W/L is not limited, but satisfies, for example, 1≤W/L.

The data track width W is obtained as follows. The cartridge 10 around which the magnetic tape MT having data recorded thereon is wound is prepared, the magnetic tape MT is unwound from the cartridge 10, and the magnetic tape MT is cut at a position of 30 m in the longitudinal direction from the connection portion 21 between the magnetic tape MT and the leader tape LT to a length of 250 mm to prepare a sample. Subsequently, a data recording pattern of the data band DB of the magnetic layer 43 of the sample is observed by using a magnetic force microscope (MFM) to obtain an MFM image. As the MFM, Dimension 3100 manufactured by Digital Instruments and its analysis software are used. A measurement region of the MFM image is 10 μm×10 μm, and the measurement region of 10 μm×10 μm is divided into 512×512 (=262,144) measurement points. Measurement by MFM is performed on three 10 μm×10 μm measurement regions at different locations in one sample, that is, three MFM images are obtained. From the obtained three MFM images, the track width is measured at ten points by using the analysis software bundled with Dimension 3100, and an average value (simple average) is obtained. The average value is the data track width W. Note that measurement conditions of the MFM described above are a sweep speed of 1 Hz, a used chip of MFMR-20, a lift height of 20 nm, and a correction of Flatten order 3.

The minimum value L of the magnetization reversal distance is obtained as follows. The cartridge 10 around which the magnetic tape MT having data recorded thereon is wound is prepared, the magnetic tape MT is unwound from the cartridge 10, and the magnetic tape MT is cut at a position of 30 m in the longitudinal direction from the connection portion 21 between the magnetic tape MT and the leader tape LT to a length of 250 mm to prepare a sample. Subsequently, a data recording pattern of the data band DB of the magnetic layer 43 of the sample is observed by using a magnetic force microscope (MFM) to obtain an MFM image. As the MFM, Dimension 3100 manufactured by Digital Instruments and its analysis software are used. A measurement region of the MFM image is 2 μm×2 μm, and the measurement region of 2 μm×2 μm is divided into 512×512 (=262,144) measurement points. Measurement by MFM is performed on three 2 μm×2 μm measurement regions at different locations in one sample, that is, three MFM images are obtained. Fifty inter-bit distances are measured from a two-dimensional unevenness chart of the recording pattern of the obtained MFM image. The inter-bit distances are measured by using the analysis software bundled with Dimension 3100. A value that is approximately the greatest common divisor of the measured 50 inter-bit distances is set as the minimum value L of the magnetization reversal distance. Note that measurement conditions are a sweep speed of 1 Hz, a used chip of MFMR-20, a lift height of 20 nm, and a correction of Flatten order 3.

The servo pattern is a magnetized region, and is formed by magnetizing a specific region of the magnetic layer 43 in a specific direction by a servo write head at a time of manufacturing the magnetic tape. In the servo band SB, a region where no servo pattern is formed (hereinafter, referred to as a “no-pattern region”) may be a magnetized region where the magnetic layer 43 is magnetized or a non-magnetized region where the magnetic layer 43 is not magnetized. In a case where the no-pattern region is the magnetized region, a region where a servo pattern is formed and the non-pattern region are magnetized in different directions (for example, opposite directions).

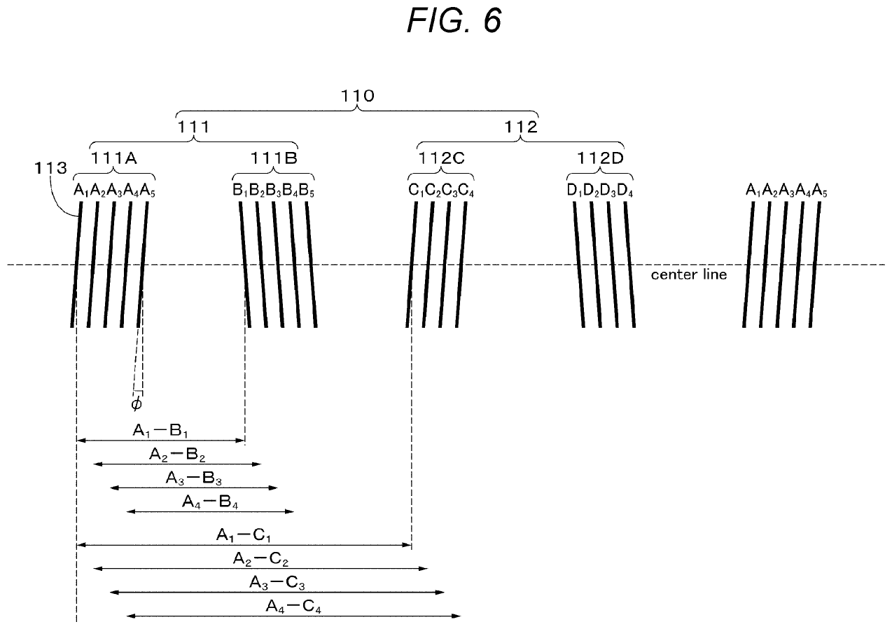

In the LTO standard, as illustrated in FIG. 6, a servo pattern including a plurality of servo stripes (linear magnetized regions) 113 inclined with respect to the width direction of the magnetic tape MT is formed on the servo band SB.

The servo band SB includes a plurality of servo frames 110. Each of the servo frames 110 includes 18 servo stripes 113. Specifically, each of the servo frames 110 includes a servo subframe 1(111) and a servo subframe 2(112).

The servo subframe 1(111) includes an A burst 111A and a B burst 111B. The B burst 111B is disposed adjacent to the A burst 111A. The A burst 111A includes five servo stripes 113 inclined at a predetermined angle φ with respect to the width direction of the magnetic tape MT and formed at specified intervals. In FIG. 6, these five servo stripes 113 are denoted by reference signs A₁, A₂, A₃, A₄, and A₅ from an end of tape (EOT) to a beginning of tape (BOT) of the magnetic tape MT. In a similar manner to the A burst 111A, the B burst 111B includes five servo pulses 63 inclined at a predetermined angle φ with respect to the width direction of the magnetic tape MT and formed at specified intervals. In FIG. 6, these five servo stripes 113 are denoted by reference signs B₁, B₂, B₃, B₄, and B₅ from the EOT to the BOT of the magnetic tape MT. The servo stripe 113 of the B burst 111B is inclined in a direction opposite to the servo stripe 113 of the A burst 111A. That is, the servo stripes 113 of the A burst 111A and the servo stripes 113 of the B burst 111B are arranged in an inverted V shape.

The servo subframe 2(112) includes a C burst 112C and a D burst 112D. The D burst 112D is disposed adjacent to the C burst 112C. The C burst 112C includes four servo stripes 113 inclined at a predetermined angle φ with respect to the width direction of the tape and formed at specified intervals. In FIG. 6, these four servo stripes 113 are denoted by reference signs C₁, C₂, C₃, and C₄ from the EOT to the BOT of the magnetic tape MT. In a similar manner to the C burst 112C, the D burst 112D includes four servo pulses 63 inclined at a predetermined angle φ with respect to the width direction of the tape and formed at specified intervals. In FIG. 6, these four servo stripes 113 are denoted by reference signs D₁, D₂, D₃, and D₄ from the EOT to the BOT of the magnetic tape MT. The servo stripe 113 of the D burst 112D is inclined in a direction opposite to the servo stripe 113 of the C burst 112C. That is, the servo stripes 113 of the C burst 112C and the servo stripes 113 of the D burst 112D are arranged in an inverted V shape.

The predetermined angle φ of the servo stripe 113 in the A burst 111A, the B burst 111B, the C burst 112C, and the D burst 112D described above is, for example, 5° or more and 25° or less, 11° or more and 25° or less, 14° or more and 25° or less, or 16° or more and 25° or less.

The servo band SB is read by using the magnetic head, and then, information for acquiring a tape speed and a position of the magnetic head in a length direction is obtained. The tape speed is calculated from time between four timing signals (A1-C1, A2-C2, A3-C3, and A4-C4). A head position is calculated from the time between the four timing signals and time between another four timing signals (A1-B1, A2-B2, A3-B3, and A4-B4).

As illustrated in FIG. 6, the servo pattern (that is, the plurality of servo stripes 113) is preferably linearly arranged in the longitudinal direction of the magnetic tape MT. That is, the servo band SB preferably has a linear shape in the longitudinal direction of the magnetic tape MT.

An upper limit value of an average thickness t₁ of the magnetic layer 43 is preferably 80 nm or less, more preferably 70 nm or less, and still more preferably 50 nm or less. When the upper limit value of the average thickness t₁ of the magnetic layer 43 is 80 nm or less, an influence of a demagnetizing field can be reduced in a case where a ring type head is used as the recording head, and thus more excellent electromagnetic conversion characteristics can be obtained.

A lower limit value of the average thickness t₁ of the magnetic layer 43 is preferably 35 nm or more. When the lower limit value of the average thickness t₁ of the magnetic layer 43 is 35 nm or more, an output can be secured in a case where an MR type head is used as a reproducing head, and thus more excellent electromagnetic conversion characteristics can be obtained.

The average thickness t₁ of the magnetic layer 43 is obtained as follows. First, the magnetic tape MT accommodated in the cartridge 10 is unwound, and the magnetic tape MT is cut to a length of 250 mm from each of a position of 10 m to 20 m, a position of 30 m to 40 m, and a position of 50 m to 60 m in the longitudinal direction from the connection portion 21 between the magnetic tape MT and the leader tape LT to prepare three samples. Subsequently, each sample is flaked by processing by a FIB method or the like. In a case where the FIB method is used, a carbon layer and a tungsten layer are formed as protective films as pretreatment for observing a TEM image of a cross section described later. The carbon layer is formed on the surface of the magnetic tape MT on a side of the magnetic layer 43 and the surface of the magnetic tape MT on a side of the back layer 44 by a vapor deposition method, and then, the tungsten layer is further formed on the surface of on the side of the magnetic layer 43 by the vapor deposition method or a sputtering method. The flaking is performed along a length direction (longitudinal direction) of the magnetic tape MT. That is, the flaking forms a cross section parallel to both the longitudinal direction and a thickness direction of the magnetic tape MT.

The cross section described above of the obtained flaked sample is observed with a transmission electron microscope (TEM) under the following conditions to obtain a TEM image. Note that a magnification and an acceleration voltage may be appropriately adjusted in accordance with the type of the device.

Device: TEM (H9000NAR manufactured by Hitachi, Ltd.)

Acceleration voltage: 300 kV

Magnification: 100,000 times

Next, by using the obtained TEM image, the thickness of the magnetic layer 43 is measured at ten points of each flaked sample. Note that the ten measurement positions of each flaked sample are randomly selected from the sample so as to be different positions in the longitudinal direction of the magnetic tape MT. An average value obtained by simply averaging (arithmetically averaging) measured values (the thicknesses of the magnetic layers 43 at 30 points in total) of each obtained flaked sample is defined as the average thickness t₁ [nm] of the magnetic layer 43.

(Magnetic Powder)

The magnetic powder includes a plurality of magnetic particles. The magnetic particles are, for example, particles including hexagonal ferrite (hereinafter, referred to as “hexagonal ferrite particles”), particles including epsilon-type iron oxide (ε iron oxide) (hereinafter, referred to as “ε iron oxide particles”), or particles including Co-containing spinel ferrite (hereinafter, referred to as “cobalt ferrite particles”). The magnetic powder is preferably crystal-oriented preferentially in a perpendicular direction of the magnetic tape MT. In the present specification, the perpendicular direction (thickness direction) of the magnetic tape MT means the thickness direction of the magnetic tape MT in a planar state.

(Hexagonal Ferrite Particles)

The hexagonal ferrite particles have, for example, a plate shape such as a hexagonal plate shape or a columnar shape such as a hexagonal columnar shape (where the thickness or height is smaller than a major axis of a plate surface or a bottom surface). In the present specification, a hexagonal slope shape includes a substantially hexagonal slope shape. In addition, the hexagonal columnar shape includes a substantially hexagonal columnar shape. The hexagonal ferrite preferably includes at least one of Ba, Sr, Pb, or Ca, and more preferably at least one of Ba or Sr. The hexagonal ferrite may be specifically, for example, barium ferrite or strontium ferrite. The barium ferrite may further include at least one of Sr, Pb, or Ca in addition to Ba. The strontium ferrite may further include at least one of Ba, Pb, or Ca in addition to Sr.

Specifically, the hexagonal ferrite has an average composition represented by a general formula MFe₁₂O₁₉. However, M is, for example, at least one metal of Ba, Sr, Pb, or Ca, preferably at least one metal of Ba or Sr. M may be a combination of Ba and one or more metals selected from the group consisting of Sr, Pb, and Ca. In addition, M may be a combination of Sr and one or more metals selected from the group consisting of Ba, Pb, and Ca. In the general formula described above, a part of Fe may be substituted with another metal element.

In a case where the magnetic powder includes hexagonal ferrite particle powder, an average particle size of the magnetic powder is preferably 13 nm or more and 22 nm or less, more preferably 13 nm or more and 19 nm or less, still more preferably 13 nm or more and 18 nm or less, particularly preferably 14 nm or more and 17 nm or less, and most preferably 14 nm or more and 16 nm or less. When the average particle size of the magnetic powder is 22 nm or less, more excellent electromagnetic conversion characteristics (for example, SNR) can be obtained in the magnetic tape MT having a high recording density. On the other hand, when the average particle size of the magnetic powder is 13 nm or more, dispersibility of the magnetic powder is further improved, and more excellent electromagnetic conversion characteristics (for example, SNR) can be obtained.

An average aspect ratio of the magnetic powder is preferably 1.0 or more and 3.0 or less, more preferably 1.5 or more and 2.8 or less, and still more preferably 1.8 or more and 2.7 or less. When the average aspect ratio of the magnetic powder is in a range of 1.0 or more and 3.0 or less, aggregation of the magnetic powder can be suppressed. In addition, when the magnetic powder is vertically oriented in a step of forming the magnetic layer 43, resistance applied to the magnetic powder can be suppressed. Therefore, the vertical orientation of the magnetic powder can be improved.

In a case where the magnetic powder includes the hexagonal ferrite particle powder, the average particle size and the average aspect ratio of the magnetic powder are obtained as follows. First, the magnetic tape MT accommodated in the cartridge 10 is unwound, and the magnetic tape MT is cut at a position of 30 m to 40 m in the longitudinal direction from the connection portion 21 between the magnetic tape MT and the leader tape LT to prepare a sample. Subsequently, the magnetic tape MT to be measured is flaked by processing by the FIB method or the like. In a case where the FIB method is used, a carbon layer and a tungsten layer are formed as protective films as pretreatment for observing a TEM image of a cross section described later. The carbon layer is formed on the surface of the magnetic tape MT on a side of the magnetic layer 43 and the surface of the magnetic tape MT on a side of the back layer 44 by a vapor deposition method, and then, the tungsten layer is further formed on the surface of on the side of the magnetic layer 43 by the vapor deposition method or a sputtering method. The flaking is performed along a length direction (longitudinal direction) of the magnetic tape MT. That is, the flaking forms a cross section parallel to both the longitudinal direction and a thickness direction of the magnetic tape MT.

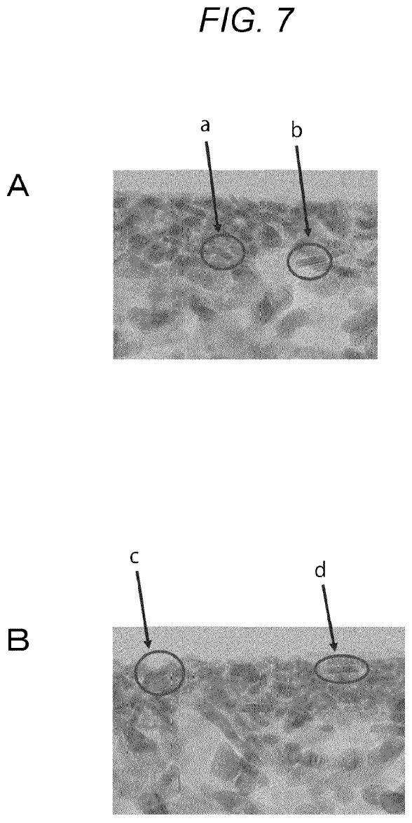

By using a transmission electron microscope (H-9500 manufactured by Hitachi High-Technologies Corporation), the cross section described above of the obtained flake sample is observed at an acceleration voltage of 200 kV and a total magnification of 500,000 times such that the entire magnetic layer 43 is included in the thickness direction of the magnetic layer 43, and TEM photographs are imaged. The TEM photographs enough to extract 50 particles of which plate diameter DB and plate thickness DA (see FIGS. 7A and 7B) described below can be measured are prepared.

In the present specification, as for a size of particles (hereinafter, referred to as “particle size”) of the hexagonal ferrite, in a case where a shape of the particles observed in the TEM photograph described above is a plate shape or a columnar shape (where the thickness or height is smaller than the major axis of the plate surface or the bottom surface) as illustrated in FIGS. 7A and 7B, the major axis of the plate surface or the bottom surface is defined as a value of the plate diameter DB. The thickness or height of the particles observed in the TEM photograph described above is defined as a value of the plate thickness DA. In a case where the plate surface or the bottom surface of the particle observed in the TEM photograph is hexagonal, the major axis means the longest diagonal distance. In a case where the thickness or height of the particle is not constant in one particle, the maximum thickness or height of the particle is defined as the plate thickness DA.

Next, 50 particles whose side surfaces are oriented in the direction of an observation surface and whose thickness can be clearly confirmed are selected from the imaged TEM photograph. Specifically, the particles are selected on the basis of the following criteria. Particles part of which protrudes outside a field of view of the TEM photograph are not measured, and particles of which outline is clear and that exists in isolation are measured. In a case where there is an overlap between the particles, when a boundary between the particles is clear and the shape of the entire particle can be determined, each particle is measured as a single particle, but when the boundary of the particles is not clear and the entire shape of the particle cannot be determined, the particle is not measured since the shape of the particle cannot be determined.

For example, FIGS. 7A and 7B each illustrate an example of the TEM photograph. In FIGS. 7A and 7B, for example, the particles indicated by arrows a and d are selected because the thicknesses (plate thickness, that is, the thickness or height of the particles) DA can be clearly confirmed. The plate thickness DA of each of the selected 50 particles is measured. The plate thicknesses DA thus obtained are simply averaged (arithmetically averaged) to obtain an average plate thickness DAₐᵥₑ. Subsequently, the plate diameter DB of each magnetic powder is measured. In order to measure the plate diameter DB of the particles, 50 particles of which plate diameter can be clearly confirmed are selected from the imaged TEM photograph. For example, in FIGS. 7A and 7B, the particles indicated by arrows b and c, for example, are selected because the plate diameters can be clearly confirmed. The plate diameter DB of each of the selected 50 particles is measured. The plate diameters DB thus obtained are simply averaged (arithmetically averaged) to obtain an average plate diameter DBₐᵥₑ. The average plate diameter DBₐᵥₑ is an average particle size. Then, the average aspect ratio (DBₐᵥₑ/DAₐᵥₑ) of the particles is obtained from the average plate thickness DAₐᵥₑ and the average plate diameter DBₐᵥₑ.

In a case where the magnetic powder includes hexagonal ferrite particle powder, an average particle volume of the magnetic powder is preferably 500 nm³ or more and 2500 nm³ or less, more preferably 500 nm³ or more and 1600 nm³ or less, still more preferably 500 nm³ or more and 1500 nm³ or less, particularly preferably 600 nm³ or more and 1200 nm³ or less, and most preferably 600 nm³ or more and 1000 nm³ or less. When the average particle volume of the magnetic powder is 2500 nm³ or less, an effect similar to an effect in a case where the average particle size of the magnetic powder is 22 nm or less is obtained. On the other hand, when the average particle volume of the magnetic powder is 500 nm³ or more, an effect similar to an effect in a case where the average particle size of the magnetic powder is 13 nm or more is obtained.

The average particle volume of the magnetic powder is obtained as follows. First, as described above regarding the method of calculating the average particle size of the magnetic powder, the average plate thickness DAₐᵥₑ and the average plate diameter DBₐᵥₑ are obtained. Next, an average volume V of the magnetic powder is obtained by the following equation.

$$V = \frac{3 \sqrt{3}}{8} \times {DA}_{ave} \times {DB}_{ave} \times {DB}_{ave} \qquad [ Equation 1 ]$$

(ε iron oxide particles)

The ε iron oxide particles are hard magnetic particles capable of obtaining a high coercive force although being fine particles. The ε iron oxide particles have a spherical shape or a cubic shape. In the present specification, a spherical shape includes a substantially spherical shape. In addition, the cubic shape includes a substantially cubic shape. Since the ε iron oxide particles have the shape as described above, in a case where the ε iron oxide particles are used as the magnetic particles, a contact area between the particles in the thickness direction of the magnetic tape MT can be reduced and aggregation of the particles can be suppressed as compared with a case where barium ferrite particles having a hexagonal plate shape are used as the magnetic particles. Therefore, the dispersibility of the magnetic powder can be enhanced, and more excellent electromagnetic conversion characteristics (for example, SNR) can be obtained.

The ε iron oxide particle has a core-shell structure. Specifically, the ε iron oxide particle includes a core and a shell having a two-layer structure provided around the core. The shell having the two-layer structure includes a first shell provided on the core and a second shell provided on the first shell.

The core includes ε iron oxide. The ε iron oxide included in the core preferably has an ε-Fe₂O₃ crystal as a main phase, and more preferably has a single phase of ε-Fe₂O₃.

The first shell covers at least a part of a periphery of the core. Specifically, the first shell may partially cover the periphery of the core or may cover the entire periphery of the core. In terms of achieving sufficient exchange coupling between the core and the first shell and improving magnetic characteristics, it is preferable to cover an entire surface of the core.

The first shell is a so-called soft magnetic layer, and includes, for example, a soft magnetic material such as α-Fe, a Ni—Fe alloy, or a Fe—Si—Al alloy. The α-Fe may be obtained by reducing ε iron oxide included in the core.

The second shell is an oxide film as an antioxidant layer. The second shell includes α-iron oxide, aluminum oxide, or silicon oxide. The α-iron oxide includes, for example, at least one iron oxide of Fe₃O₄, Fe₂O₃, or FeO. In a case where the first shell includes α-Fe (soft magnetic material), the α-iron oxide may be obtained by oxidizing α-Fe included in the first shell.

The ε iron oxide particle having the first shell as described above can adjust a coercive force Hc of the ε iron oxide particle (core-shell particle) as a whole to the coercive force Hc suitable for recording while maintaining the coercive force Hc of the core alone at a large value in order to secure thermal stability. In addition, since the ε iron oxide particle has the second shell as described above, it is possible to suppress deterioration of characteristics of the ε iron oxide particle due to generation of rust or the like on the particle surface due to exposure of the ε iron oxide particle to the air in and before a manufacturing step of the magnetic tape MT. Therefore, characteristic deterioration of the magnetic tape MT can be suppressed.

The ε iron oxide particle may have a shell having a single layer structure. In this case, the shell has a similar configuration to the first shell. However, in terms of suppressing characteristic deterioration of the s iron oxide particles, the ε iron oxide particle preferably has a shell having a two-layer structure as described above.

The ε iron oxide particle may include an additive instead of a core-shell structure described above, or may have a core-shell structure and include an additive. In this case, a part of Fe in the ε iron oxide particle is substituted with an additive. The ε iron oxide particle including an additive can also adjust the coercive force Hc of the ε iron oxide particle as a whole to the coercive force Hc suitable for recording, and thus can improve recordability. The additive is a metal element other than iron, preferably a trivalent metal element, more preferably at least one of Al, Ga, or In, and still more preferably at least one of Al or Ga.

Specifically, the ε iron oxide including the additive is a ε-Fe₂₋ₓMₓO₃ crystal (where M is a metal element other than iron, preferably a trivalent metal element, more preferably at least one of Al, Ga, or In, and still more preferably at least one of Al or Ga, and x satisfies, for example, 0<x<1).

In a case where the magnetic powder includes the ε iron oxide particles, the average particle size (average maximum particle size) of the magnetic powder is preferably 10 nm or more and 20 nm or less, more preferably 10 nm or more and 18 nm or less, still more preferably 10 nm or more and 16 nm or less, particularly preferably 10 nm or more and 15 nm or less, and most preferably 10 nm or more and 14 nm or less. In the magnetic tape MT, a region having a size of ½ of a recording wavelength is an actual magnetized region. Thus, by setting the average particle size of the magnetic powder to half or less of the shortest recording wavelength, more excellent electromagnetic conversion characteristics (for example, SNR) can be obtained. Therefore, when the average particle size of the magnetic powder is 20 nm or less, more excellent electromagnetic conversion characteristics (for example, SNR) can be obtained in the magnetic tape MT having a high recording density (for example, the magnetic tape MT configured to be capable of recording a signal at the shortest recording wavelength of 40 nm or less). On the other hand, when the average particle size of the magnetic powder is 10 nm or more, dispersibility of the magnetic powder is further improved, and more excellent electromagnetic conversion characteristics (for example, SNR) can be obtained.

The average aspect ratio of the magnetic powder is preferably 1.0 or more and 3.0 or less, more preferably 1.0 or more and 2.5 or less, still more preferably 1.0 or more and 2.1 or less, and particularly preferably 1.0 or more and 1.8 or less. When the average aspect ratio of the magnetic powder is in a range of 1.0 or more and 3.0 or less, aggregation of the magnetic powder can be suppressed. In addition, when the magnetic powder is vertically oriented in a step of forming the magnetic layer 43, resistance applied to the magnetic powder can be suppressed. Therefore, the vertical orientation of the magnetic powder can be improved.

In a case where the magnetic powder includes the ε iron oxide particle powder, the average particle size and the average aspect ratio of the magnetic powder are obtained as follows. First, the magnetic tape MT to be measured is flaked by processing by the focused ion beam (FIB) method or the like. In a case where the FIB method is used, a carbon layer and a tungsten layer are formed as protective layers as pretreatment for observing a TEM image of a cross section described later. The carbon layer is formed on the surface of the magnetic tape MT on a side of the magnetic layer 43 and the surface of the magnetic tape MT on a side of the back layer 44 by a vapor deposition method, and then, the tungsten layer is further formed on the surface of on the side of the magnetic layer 43 by the vapor deposition method or a sputtering method. The flaking is performed along a length direction (longitudinal direction) of the magnetic tape MT. That is, the flaking forms a cross section parallel to both the longitudinal direction and a thickness direction of the magnetic tape MT.

By using a transmission electron microscope (H-9500 manufactured by Hitachi High-Technologies Corporation), the cross section described above of the obtained flake sample is observed at an acceleration voltage of 200 kV and a total magnification of 500,000 times such that the entire magnetic layer 43 is included in the thickness direction of the magnetic layer 43, and TEM photographs are imaged. Next, 50 particles whose shapes can be clearly confirmed are selected from the imaged TEM photograph, and a long axis length DL and a short axis length DS of each particle are measured. Here, the long axis length DL means the largest distance among distances between two parallel lines drawn from all angles so as to be in contact with a contour of each particle (so-called maximum Feret diameter). On the other hand, the short axis length DS means the maximum length of the particle in a direction orthogonal to the long axis (DL) of the particle. Subsequently, the measured long axis lengths DL of the 50 particles are simply averaged (arithmetically averaged) to obtain an average long axis length DLₐᵥₑ. The average long axis length DLₐᵥₑ thus obtained is defined as the average particle size of the magnetic powder. In addition, the measured short axis lengths DS of the 50 particles are simply averaged (arithmetically averaged) to obtain an average short axis length DSₐᵥₑ. Then, the average aspect ratio (DLₐᵥₑ/DSₐᵥₑ) of the particles is obtained from the average long axis length DLₐᵥₑ and the average short axis length DSₐᵥₑ.

The average particle volume of the magnetic powder is preferably 500 nm³ or more and 4000 nm³ or less, more preferably 500 nm³ or more and 3000 nm³ or less, still more preferably 500 nm³ or more and 2000 nm³ or less, particularly preferably 600 nm³ or more and 1600 nm³ or less, and most preferably 600 nm³ or more and 1300 nm³ or less. In general, since noise of the magnetic tape MT is inversely proportional to the square root of the number of particles (that is, proportional to the square root of a particle volume), more excellent electromagnetic conversion characteristics (for example, SNR) can be obtained by reducing the particle volume. Therefore, when the average particle volume of the magnetic powder is 4000 nm³ or less, in a similar manner to a case where the average particle size of the magnetic powder is 20 nm or less, more excellent electromagnetic conversion characteristics (for example, SNR) can be obtained. On the other hand, when the average particle volume of the magnetic powder is 500 nm³ or more, an effect similar to the effect in a case where the average particle size of the magnetic powder is 10 nm or more is obtained.

In a case where the ε iron oxide particle has a spherical shape, the average particle volume of the magnetic powder is determined as follows. First, the average long axis length DLₐᵥₑ is obtained in a similar manner to the method of calculating the average particle size of the magnetic powder described above. Next, an average volume V of the magnetic powder is obtained by the following equation.

V=(π/6)×DLₐᵥₑ³

In a case where the ε iron oxide particle has a cubic shape, the average volume of the magnetic powder is obtained as follows. The magnetic tape MT is flaked by processing by the focused ion beam (FIB) method or the like. In a case where the FIB method is used, a carbon film and a tungsten thin film are formed as protective films as pretreatment for observing a TEM image of a cross section described later. The carbon film is formed on the surface of the magnetic tape MT on the side of the magnetic layer 43 and the surface of the magnetic tape MT on a side of the back layer 44 side by the vapor deposition method, and then, the tungsten film is further formed on the surface of on the side of the magnetic layer 43 by the vapor deposition method or the sputtering method. The flaking is performed along a length direction (longitudinal direction) of the magnetic tape MT. That is, the flaking forms a cross section parallel to both the longitudinal direction and a thickness direction of the magnetic tape MT.

By using a transmission electron microscope (H-9500 manufactured by Hitachi High-Technologies Corporation), the obtained flake sample is observed at an acceleration voltage of 200 kV and a total magnification of 500,000 times such that the entire magnetic layer 43 is included in the thickness direction of the magnetic layer 43, and a TEM photograph is obtained. Note that a magnification and an acceleration voltage may be appropriately adjusted in accordance with the type of the device. Next, 50 particles whose shapes are clear are selected from the imaged TEM photograph, and a side length DC of each particle is measured. Subsequently, the measured side lengths DC of the 50 particles are simply averaged (arithmetically averaged) to obtain an average side length DCₐᵥₑ. Next, an average volume Vₐᵥₑ (particle volume) of the magnetic powder is obtained from the following equation by using the average side length DCₐᵥₑ.

Vₐᵥₑ=DCₐᵥₑ³

(Cobalt Ferrite Particles)

The cobalt ferrite particles preferably have uniaxial crystal anisotropy. The cobalt ferrite particles, which have uniaxial crystal anisotropy, can cause the magnetic powder to be preferentially crystal-oriented in the perpendicular direction of the magnetic tape MT. The cobalt ferrite particles have, for example, a cubic shape. In the present specification, a cubic shape includes a substantially cubic shape. The Co-containing spinel ferrite may further include at least one of Ni, Mn, Al, Cu, or Zn in addition to Co.

The Co-containing spinel ferrite has, for example, an average composition represented by the following formula.

CoₓM_{y}Fe₂O_{z}

(where M is, for example, at least one metal of Ni, Mn, Al, Cu, or Zn in the formula. x is a value in a range of 0.4≤x≤1.0. y is a value in a range of 0≤y≤0.3. Note that x and y satisfy a relationship of (x+y)≤1.0. z is a value in a range of 3≤z≤4. A part of Fe may be substituted with another metal element.)

In a case where the magnetic powder includes cobalt ferrite particle powder, the average particle size of the magnetic powder is preferably 8 nm or more and 20 nm or less, more preferably 8 nm or more and 18 nm or less, still more preferably 8 nm or more and 16 nm or less, particularly preferably 8 nm or more and 13 nm or less, and most preferably 8 nm or more and 10 nm or less. When the average particle size of the magnetic powder is 20 nm or less, more excellent electromagnetic conversion characteristics (for example, SNR) can be obtained in the magnetic tape MT having a high recording density. On the other hand, when the average particle size of the magnetic powder is 8 nm or more, dispersibility of the magnetic powder is further improved, and more excellent electromagnetic conversion characteristics (for example, SNR) can be obtained. A method of calculating the average particle size of the magnetic powder is similar to the method of calculating the average particle size of the magnetic powder in a case where the magnetic powder includes ε iron oxide particle powder.

The average aspect ratio of the magnetic powder is preferably 1.0 or more and 3.0 or less, more preferably 1.0 or more and 2.5 or less, still more preferably 1.0 or more and 2.1 or less, and particularly preferably 1.0 or more and 1.8 or less. When the average aspect ratio of the magnetic powder is in a range of 1.0 or more and 3.0 or less, aggregation of the magnetic powder can be suppressed. In addition, when the magnetic powder is vertically oriented in a step of forming the magnetic layer 43, resistance applied to the magnetic powder can be suppressed. Therefore, the vertical orientation of the magnetic powder can be improved. A method of calculating the average aspect ratio of the magnetic powder is similar to the method of calculating the average aspect ratio of the magnetic powder in a case where the magnetic powder includes ε iron oxide particle powder.

The average particle volume of the magnetic powder is preferably 500 nm³ or more and 8000 nm³ or less, more preferably 500 nm³ or more and 6000 nm³ or less, still more preferably 500 nm³ or more and 4000 nm³ or less, particularly preferably 600 nm³ or more and 2000 nm³ or less, and most preferably 600 nm³ or more and 1000 nm³ or less. When the average particle volume of the magnetic powder is 8000 nm³ or less, an effect similar to an effect in a case where the average particle size of the magnetic powder is 20 nm or less is obtained. On the other hand, when the average particle volume of the magnetic powder is 500 nm³ or more, an effect similar to the effect in a case where the average particle size of the magnetic powder is 8 nm or more is obtained. A method for calculating the average particle volume of the magnetic powder is similar to the method for calculating the average particle volume in a case where the ε iron oxide particles have a cubic shape.

(Binder)

Examples of the binder include thermoplastic resins, thermosetting resins, reactive resins, and the like. Examples of the thermoplastic resin include vinyl chloride, vinyl acetate, vinyl chloride-vinyl acetate copolymer, vinyl chloride-vinylidene chloride copolymer, vinyl chloride-acrylonitrile copolymer, acrylic acid ester-acrylonitrile copolymer, acrylic acid ester-vinyl chloride-vinylidene chloride copolymer, acrylic acid ester-acrylonitrile copolymer, acrylic acid ester-vinylidene chloride copolymer, methacrylic acid ester-vinylidene chloride copolymer, methacrylic acid ester-vinyl chloride copolymer, methacrylic acid ester-ethylene copolymer, polyvinyl fluoride, vinylidene chloride-acrylonitrile copolymer, acrylonitrile-butadiene copolymer, polyamide resin, polyvinyl butyral, cellulose derivatives (cellulose acetate butyrate, cellulose diacetate, cellulose triacetate, and cellulose propionate, nitrocellulose), styrene-butadiene copolymer, polyurethane resin, polyester resin, amino resin, synthetic rubber, and the like.

Examples of the thermosetting resin include a phenol resin, epoxy resin, polyurethane curable resin, urea resin, melamine resin, alkyd resin, silicone resin, polyamine resin, urea formaldehyde resin, and the like.

In order to improve the dispersibility of the magnetic powder, polar functional groups such as —SO₃M, —OSO₃M, —COOM, P═O(OM)₂ (where M represents a hydrogen atom or an alkali metal such as lithium, potassium, or sodium in the formula), a side chain type amine having an end group represented by —NR1R2, —NR1R2R3⁺X⁻, a main chain type amine represented by >NR1R2⁺X⁻ (where R1, R2, and R3 represent a hydrogen atom or a hydrocarbon group, and X⁻ represents a halogen element ion such as fluorine, chlorine, bromine, or iodine, an inorganic ion, or an organic ion in the formula), and —OH, —SH, —CN, or an epoxy group may be introduced into all the binders described above. An introduction amount of these polar functional groups into the binder is preferably 10⁻¹ mol/g or more and 10⁻⁸ mol/g or less, and more preferably 10⁻² mol/g or more and 10⁻⁶ mol/g or less.

(Lubricant)

The lubricant includes, for example, at least one selected from fatty acid and fatty acid ester, preferably both fatty acid and fatty acid ester. The fact that the magnetic layer 43 includes a lubricant, in particular, the fact that the magnetic layer 43 includes both a fatty acid and a fatty acid ester contributes to improvement of running stability of the magnetic tape MT. More particularly, since the magnetic layer 43 includes a lubricant and has pores, good running stability is achieved. The running stability is considered to be improved because a dynamic friction coefficient of the surface of the magnetic tape MT on the side of the magnetic layer 43 is adjusted to a value suitable for running of the magnetic tape MT by the lubricant described above.

The fatty acid may be preferably a compound represented by the following general formula (1) or (2). For example, one of the compound represented by the following general formula (1) or the compound represented by general formula (2) may be included as the fatty acid, or both the compound represented by the following general formula (1) and the compound represented by general formula (2) may be included as the fatty acid.

In addition, the fatty acid ester may be preferably a compound represented by the following general formula (3) or (4). For example, one of the compound represented by the following general formula (3) or the compound represented by general formula (4) may be included as the fatty acid ester, or both the compound represented by the following general formula (3) and the compound represented by general formula (4) may be included as the fatty acid ester.

By the lubricant including any one or both of the compound represented by the general formula (1) or/and the compound represented by the general formula (2) and any one or both of the compound represented by the general formula (3) or/and the compound represented by the general formula (4), an increase in the dynamic friction coefficient due to repeated recording or reproduction of the magnetic tape MT can be suppressed.

CH₃(CH₂)ₖCOOH (1)

(where, in the general formula (1), k is an integer selected from a range of 14 or more and 22 or less, and more preferably a range of 14 or more and 18 or less.)

CH₃(CH₂)ₙCH═CH(CH₂)ₘCOOH (2)

(where, in the general formula (2), the sum of n and m is an integer selected from a range of 12 or more and 20 or less, and more preferably a range of 14 or more and 18 or less.)

CH₃(CH₂)ₚCOO(CH₂)_{q}CH₃ (3)

(where, in the general formula (3), p is an integer selected from a range of 14 or more and 22 or less, more preferably a range of 14 or more and 18 or less, and q is an integer selected from a range of 2 or more and 5 or less, more preferably a range of 2 or more and 4 or less.)

CH₃(CH₂)ᵣCOO—(CH₂)ₛCH(CH₃)₂ (4)

(where, in the general formula (4), r is an integer selected from a range of 14 or more and 22 or less, and s is an integer selected from a range of 1 or more and 3 or less.)

(Antistatic Agent)

Examples of the antistatic agent include carbon black, a natural surfactant, a nonionic surfactant, a cationic surfactant, and the like.

(Abrading Agent)

Examples of the abrading agent include α-alumina having a gelatinization rate of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing a raw material of magnetic iron oxide, those surface-treated with aluminum and/or silica as necessary, and the like.

(Curing Agent)

Examples of the curing agent include polyisocyanate and the like. Examples of the polyisocyanate include aromatic polyisocyanates such as an adduct of tolylene diisocyanate (TDI) and an active hydrogen compound, and aliphatic polyisocyanates such as an adduct of hexamethylene diisocyanate (HMDI), an active hydrogen compound, and the like. The polyisocyanates desirably have a weight average molecular weight in a range of 100 or more and 3000 or less.

(Rust Inhibitor)

Examples of the rust inhibitor include phenols, naphthols, quinones, heterocyclic compounds containing a nitrogen atom, heterocyclic compounds containing an oxygen atom, heterocyclic compounds containing a sulfur atom, and the like.

(Nonmagnetic Reinforcing Particles)

Examples of the nonmagnetic reinforcing particles include aluminum oxide (α, β, or γ alumina), chromium oxide, silicon oxide, diamond, garnet, emery, boron nitride, titanium carbide, silicon carbide, titanium carbide, titanium oxide (rutile type or anatase type titanium oxide), and the like.

(Underlayer)

The underlayer 42 alleviates unevenness on the surface of the substrate 41 and adjusts unevenness on the surface of the magnetic layer 43. The underlayer 42 is a nonmagnetic layer including nonmagnetic powder, a binder, and a lubricant. The underlayer 42 supplies the lubricant to the surface of the magnetic layer 43. The underlayer 42 may further include at least one additive of an antistatic agent, a curing agent, a rust inhibitor, or the like as necessary.

An average thickness t₂ of the underlayer 42 is, for example, 0.3 μm or more and 1.4 μm or less, preferably 0.3 μm or more and 1.2 μm or less, more preferably 0.3 μm or more and 1.0 μm or less, and still more preferably 0.3 μm or more and 0.5 μm or less. Note that the average thickness t₂ of the underlayer 42 is obtained in a similar manner to the average thickness ti of the magnetic layer 43. However, a magnification of the TEM image is appropriately adjusted in accordance with the thickness of the underlayer 42. When the average thickness t₂ of the underlayer 42 is 1.2 μm or less, stretchability of the magnetic tape MT due to an external force is further enhanced, and thus adjustment of the width of the magnetic tape MT by tension adjustment is further facilitated.

The underlayer 42 preferably has a plurality of holes. By storing the lubricant in the plurality of holes, it is possible to further suppress a decrease in an amount of lubricant supplied between the surface of the magnetic layer 43 and the magnetic head even after repeated recording or reproduction (that is, even after running with the magnetic head in contact with the surface of the magnetic tape MT). Therefore, the increase in the dynamic friction coefficient can be further suppressed. That is, more excellent running stability can be obtained.

(Nonmagnetic Powder)

The nonmagnetic powder includes, for example, at least one of inorganic particle powder or organic particle powder. In addition, the nonmagnetic powder may include carbon powder such as carbon black. Note that one kind of nonmagnetic powder may be used alone, or two or more kinds of nonmagnetic powders may be used in combination. The inorganic particles include, for example, a metal, a metal oxide, a metal carbonate, a metal sulfate, a metal nitride, a metal carbide, a metal sulfide, or the like. Examples of a shape of the nonmagnetic powder include various shapes such as a needle shape, a spherical shape, a cubic shape, and a plate shape, but are not limited to these shapes.

(Binder and Lubricant)

The binder and the lubricant are similar to those of the magnetic layer 43 described above.

(Additive)

The antistatic agent, the curing agent, and the rust inhibitor are similar to those of the magnetic layer 43 described above.

(Back Layer)

The back layer 44 includes a binder and nonmagnetic powder. The back layer 44 may further include at least one additive of a lubricant, a curing agent, an antistatic agent, or the like as necessary. The binder and the nonmagnetic powder are similar to those of the underlayer 42 described above. The curing agent and the antistatic agent are similar to those of the magnetic layer 43 described above.

An average particle size of the nonmagnetic powder is preferably 10 nm or more and 150 nm or less, and more preferably 15 nm or more and 110 nm or less. The average particle size of the nonmagnetic powder is obtained in a similar manner to the average particle size of the magnetic powder described above. The nonmagnetic powder may include a nonmagnetic powder having two or more particle size distributions.

An upper limit value of an average thickness of the back layer 44 is preferably 0.6 μm or less. When the upper limit value of the average thickness of the back layer 44 is 0.6 μm or less, even in a case where the average thickness of the magnetic tape MT is 5.3 μm or less, the thicknesses of the underlayer 42 and the substrate 41 can be kept thick, and the running stability of the magnetic tape MT in the recording and reproducing device can be maintained. A lower limit value of the average thickness of the back layer 44 is not limited, but is, for example, 0.2 μm or more.

An average thickness t_{b} of the back layer 44 is obtained as follows. First, an average thickness t_{T} of the magnetic tape MT is measured. A method for measuring the average thickness t_{T} is as described in “Average thickness of magnetic tape” below. Subsequently, the magnetic tape MT accommodated in the cartridge 10 is unwound, and the magnetic tape MT is cut to a length of 250 mm at a position of 30 m to 40 m in the longitudinal direction from a connection portion 21 between the magnetic tape MT and the leader tape LT to prepare a sample. Next, the back layer 44 of the sample is removed with a solvent such as methyl ethyl ketone (MEK) or dilute hydrochloric acid. Next, a thickness of the sample is measured at five positions by using Laser Hologauge (LGH-110C) manufactured by Mitutoyo Corporation, and measured values are simply averaged (arithmetic average) to calculate the average value t_{B}[μm]. Thereafter, the average thickness t_{b} [μm] of the back layer 44 is obtained by the following equation. Note that the five measurement positions described above are randomly selected from the sample so as to be different positions in the longitudinal direction of the magnetic tape MT.

t_{b}[μm]=t_{T}[μm]−t_{B}[μm]

(Average Thickness of Magnetic Tape)

An upper limit value of the average thickness (average total thickness) t_{T} of the magnetic tape MT is preferably 5.3 μm or less, more preferably 5.0 μm or less, still more preferably 4.8 μm or less, particularly preferably 4.6 μm or less, and most preferably 4.4 μm or less. When the average thickness t_{T} of the magnetic tape MT is 5.3 μm or less, the recording capacity that for recording in one data cartridge can be increased as compared with a general magnetic tape. A lower limit value of the average thickness t_{T} of the magnetic tape MT is not limited, but is, for example, 3.5 μm or more.

The average thickness t_{T} of the magnetic tape MT is obtained as follows. First, the magnetic tape MT accommodated in the cartridge 10 is unwound, and the magnetic tape MT is cut to a length of 250 mm at a position of 30 m to 40 m in the longitudinal direction from a connection portion 21 between the magnetic tape MT and the leader tape LT to prepare a sample. Next, a thickness of the sample is measured at five positions by using Laser Hologauge (LGH-110C) manufactured by Mitutoyo Corporation, and measured values are simply averaged (arithmetic average) to calculate the average value t_{T}[μm]. Note that the five measurement positions described above are randomly selected from the sample so as to be different positions in the longitudinal direction of the magnetic tape MT.

(Coercive Force Hc2)

An upper limit value of a coercive force Hc2 of the magnetic layer 43 in the longitudinal direction of the magnetic tape MT is preferably 3000 Oe or less, more preferably 2000 Oe or less, still more preferably 1900 Oe or less, and particularly preferably 1800 Oe or less. When the coercive force Hc2 of the magnetic layer 43 in the longitudinal direction of the magnetic tape MT is 2000 Oe or less, sufficient electromagnetic conversion characteristics can be achieved even at a high recording density.

A lower limit value of the coercive force Hc2 of the magnetic layer 43 measured in the longitudinal direction of the magnetic tape MT is preferably 1000 Oe or more. When the coercive force Hc2 of the magnetic layer 43 measured in the longitudinal direction of the magnetic tape MT is 1000 Oe or more, demagnetization caused by magnetic flux leakage from the recording head can be suppressed.

The coercive force Hc2 described above is obtained as follows. First, the magnetic tape MT accommodated in the cartridge 10 is unwound, and the magnetic tape MT is cut at a position of 30 m to 40 m in the longitudinal direction from the connection portion 21 between the magnetic tape MT and the leader tape LT. Three sheets of the magnetic tape MT are superimposed on each other with a double-sided tape such that the directions of the magnetic tape MT in the longitudinal direction are the same, and then punched out with a punch of D 6.39 mm to prepare a measurement sample. At this time, a mark is made with an arbitrary ink having no magnetism so that the longitudinal direction (running direction) of the magnetic tape MT can be recognized. Then, an M-H loop of the measurement sample (the entire magnetic tape MT) corresponding to the longitudinal direction (running direction) of the magnetic tape MT is measured by using a vibrating sample magnetometer (VSM). Next, a coating film (underlayer 42, magnetic layer 43, back layer 44, and the like) of the magnetic tape MT cut as described above is wiped off with acetone, ethanol, or the like to leave only the substrate 41. Then, three substrates 41 obtained are stacked with a double-sided tape, and then punched out with a punch of D 6.39 mm to prepare a sample for background correction (hereinafter, simply referred to as “correction sample”). Thereafter, the M-H loop of the correction sample (substrate 41) corresponding to the longitudinal direction of the substrate 41 (longitudinal direction of the magnetic tape MT) is measured by using the VSM.

In the measurement of the M-H loop of the measurement sample (the entire magnetic tape MT) and the M-H loop of the correction sample (the substrate 41), a high sensitivity vibrating sample magnetometer “VSM-P7-15” manufactured by Toei Industry Co., Ltd. is used. Measurement conditions are a measurement mode of full loop, a maximum magnetic field of 15 kOe, a magnetic field step of 40 bits, a time constant of locking amp of 0.3 sec, waiting time of 1 sec, and a MH average number of 20.

After the M-H loop of the measurement sample (the entire magnetic tape MT) and the M-H loop of the correction sample (the substrate 41) are obtained, the M-H loop of the correction sample (the substrate 41) is subtracted from the M-H loop of the measurement sample (the entire magnetic tape MT) to perform background correction, and an M-H loop after the background correction is obtained. For the calculation of the background correction, a measurement and analysis program bundled with the “VSM-P7-15” is used. The coercive force Hc2 is obtained from the obtained M-H loop after the background correction. Note that the measurement and analysis program bundled with the “VSM-P7-15” is used for the calculation. Note that the M-H loop is measured at 25° C. in both cases described above. Furthermore, “demagnetizing field correction” when measuring the M-H loop in the longitudinal direction of the magnetic tape MT is not performed.

(Squareness Ratio)

A squareness ratio Si of the magnetic layer 43 in the perpendicular direction of the magnetic tape MT is preferably 65% or more, more preferably 70% or more, still more preferably 75% or more, particularly preferably 80% or more, and most preferably 85% or more. When the squareness ratio S1 is 65% or more, the perpendicular orientation of the magnetic powder is sufficiently high, and more excellent electromagnetic conversion characteristics can be obtained.

The squareness ratio S1 in the perpendicular direction of the magnetic tape MT is determined as follows. First, the magnetic tape MT accommodated in the cartridge 10 is unwound, and the magnetic tape MT is cut at a position of 30 m to 40 m in the longitudinal direction from the connection portion 21 between the magnetic tape MT and the leader tape LT. Three sheets of the magnetic tape MT are superimposed on each other with a double-sided tape such that the directions of the magnetic tape MT in the longitudinal direction are the same, and then punched out with a punch of D 6.39 mm to prepare a measurement sample. At this time, a mark is made with an arbitrary ink having no magnetism so that the longitudinal direction (running direction) of the magnetic tape MT can be recognized. Then, the M-H loop of the measurement sample (the entire magnetic tape MT) corresponding to the perpendicular direction (thickness direction) of the magnetic tape MT is measured by using the VSM. Next, the coating film (the underlayer 42, the magnetic layer 43, the back layer 44, and the like) is wiped off with acetone, ethanol, or the like to leave only the substrate 41. Then, three substrates 41 obtained are stacked with a double-sided tape, and then punched out with a punch of D 6.39 mm to make a sample for background correction (hereinafter, simply referred to as “correction sample”). Thereafter, the M-H loop of the correction sample (substrate 41) corresponding to the perpendicular direction of the substrate 41 (perpendicular direction of the magnetic tape MT) is measured by using the VSM.

In the measurement of the M-H loop of the measurement sample (the entire magnetic tape MT) and the M-H loop of the correction sample (the substrate 41), a high sensitivity vibrating sample magnetometer “VSM-P7-15” manufactured by Toei Industry Co., Ltd. is used. Measurement conditions are a measurement mode of full loop, a maximum magnetic field of 15 kOe, a magnetic field step of 40 bits, a time constant of locking amp of 0.3 sec, waiting time of 1 sec, and a MH average number of 20.

After the M-H loop of the measurement sample (the entire magnetic tape MT) and the M-H loop of the correction sample (the substrate 41) are obtained, the M-H loop of the correction sample (the substrate 41) is subtracted from the M-H loop of the measurement sample (the entire magnetic tape MT) to perform background correction, and an M-H loop after the background correction is obtained. For the calculation of the background correction, a measurement and analysis program bundled with the “VSM-P7-15” is used.

The squareness ratio Si (%) is calculated by substituting saturated magnetization Ms (emu) and residual magnetization Mr (emu) of the obtained M-H loop after the background correction into the following equation. Note that the M-H loop is measured at 25° C. in both cases described above. Furthermore, “demagnetizing field correction” when measuring the M-H loop in the perpendicular direction of the magnetic tape MT is not performed. Note that the measurement and analysis program bundled with the “VSM-P7-15” is used for the calculation.

Squareness ratio S1(%)=(Mr/Ms)×100

A squareness ratio S2 of the magnetic layer 43 in the longitudinal direction (running direction) of the magnetic tape MT is preferably 35% or less, more preferably 30% or less, still more preferably 25% or less, particularly preferably 20% or less, and most preferably 15% or less. When the squareness ratio S2 is 35% or less, the perpendicular orientation of the magnetic powder is sufficiently high, and more excellent electromagnetic conversion characteristics can be obtained.

The squareness ratio S2 in the longitudinal direction of the magnetic tape MT is obtained in a similar manner to the squareness ratio Si except that the M-H loop is measured in the longitudinal direction (running direction) of the magnetic tape MT and the substrate 41.

(Ratio Hc2/Hc1) A ratio Hc2/Hc1 of the coercive force Hc1 of the magnetic layer 43 in the perpendicular direction of the magnetic tape MT to the coercive force Hc2 of the magnetic layer 43 in the longitudinal direction of the magnetic tape MT preferably satisfies a relationship of Hc2/Hc1≤0.8, more preferably Hc2/Hc1≤0.75, still more preferably Hc2/Hc1≤0.7, particularly preferably Hc2/Hc1≤0.65, and most preferably Hc2/Hc1≤0.6. When the coercive forces Hc1 and Hc2 satisfy the relationship of Hc2/Hc1≤0.8, a degree of vertical orientation of the magnetic powder can be increased. Therefore, a magnetization transition width can be reduced and a high-output signal can be obtained at a time of signal reproduction, and thus more excellent electromagnetic conversion characteristics can be obtained. Note that, as described above, when Hc2 is small, magnetization reacts with high sensitivity by the magnetic field in the perpendicular direction from the recording head, and thus a good recording pattern can be formed.

In a case where the ratio Hc2/Hc1 satisfies Hc2/Hc1≤0.8, it is particularly effective that the average thickness tᵢ of the magnetic layer 43 is 90 nm or less. If the average thickness tᵢ of the magnetic layer 43 exceeds 90 nm, in a case where a ring type head is used as a recording head, a lower region (region on a side of the underlayer 42) of the magnetic layer 43 is magnetized in the longitudinal direction of the magnetic tape MT, and there is a possibility that the magnetic layer 43 cannot be uniformly magnetized in the thickness direction. Therefore, even if the ratio Hc2/Hc1 satisfies Hc2/Hc1≤0.8 (that is, even if the degree of vertical orientation of the magnetic powder is increased), there is a possibility that more excellent electromagnetic conversion characteristics cannot be obtained.

A lower limit value of Hc2/Hc1 is not limited, but is, for example, 0.5≤Hc2/Hc1. Note that Hc2/Hc1 represents the degree of vertical orientation of the magnetic powder, and the smaller Hc2/Hc1, the higher the degree of vertical orientation of the magnetic powder.

A method of calculating the coercive force Hc2 of the magnetic layer 43 in the longitudinal direction of the magnetic tape MT is as described above. The coercive force Hc1 of the magnetic layer 43 in the perpendicular direction of the magnetic tape MT is obtained in a similar manner to the coercive force Hc2 of the magnetic layer 43 in the longitudinal direction of the magnetic tape MT except that the M-H loop is measured in the perpendicular direction (thickness direction) of the magnetic tape MT and the substrate 41.

(Activation Volume V_{act})

An activation volume V_{act} is preferably 8000 nm³ or less, more preferably 6000 nm³ or less, still more preferably 5000 nm³ or less, particularly preferably 4000 nm³ or less, and most preferably 3000 nm³ or less. When the activation volume V_{act} is 8000 nm³ or less, a good dispersion state of the magnetic powder can make a bit inversion region sharp, and deterioration of the magnetization signal recorded in adjacent tracks due to magnetic field leakage from the recording head can be suppressed. Therefore, there is a possibility that more excellent electromagnetic conversion characteristics cannot be obtained.

The activation volume V_{act} described above is obtained by the following equation derived by Street & Woolley.

V_{act}(nm³)=k_{B}×T×Xᵢᵣᵣ/(μ₀×Ms×S)

(where k_{B} is Boltzmann constant (1.38×10⁻²³ J/K), T is temperature (K), Xᵢᵣᵣ is irreversible magnetic susceptibility, μ₀ is vacuum magnetic permeability, S is a magnetic viscosity coefficient, and Ms is saturated magnetization (emu/cm³).)

The irreversible magnetic susceptibility Xᵢᵣᵣ, the saturated magnetization Ms, and a magnetic viscosity coefficient S substituted into the equation described above are obtained as follows by using the VSM. Note that a measurement direction by the VSM is the perpendicular direction (thickness direction) of the magnetic tape MT. In addition, the measurement by the VSM is performed at 25° C. on a measurement sample cut from the elongated magnetic tape MT. Furthermore, “demagnetizing field correction” when measuring the M-H loop in the perpendicular direction (thickness direction) of the magnetic tape MT is not performed.

(Irreversible Magnetic Susceptibility Xᵢᵣᵣ)

The irreversible magnetic susceptibility Xᵢᵣᵣ is defined as an inclination near a residual coercive force Hr in an inclination of a residual magnetization curve (DCD curve). First, a magnetic field of −1193 kA/m (15 kOe) is applied to the entire magnetic tape MT, and the magnetic field is returned to 0 to obtain a residual magnetization state. Thereafter, a magnetic field of about 15.9 kA/m (200 Oe) is applied in the opposite direction and returned to 0 again, and a residual magnetization amount is measured. Thereafter, in a similar manner, measurement of applying a magnetic field larger than the magnetic field previously applied by 15.9 kA/m and returning the magnetic field to 0 is repeated, and a residual magnetization amount is plotted against the applied magnetic field to measure a DCD curve. From the obtained DCD curve, a point at which a magnetization amount becomes zero is defined as the residual coercive force Hr, the DCD curve is further differentiated, and the inclination of the DCD curve in each magnetic field is obtained. In the inclination of the DCD curve, the inclination near the residual coercive force Hr is Xᵢᵣᵣ.

(Saturated Magnetization Ms)

First, an M-H loop after the background correction is obtained in a similar manner to the method of measuring the squareness ratio Si described above. Next, Ms (emu/cm³) is calculated from a value of the saturated magnetization Ms (emu) of the obtained M-H loop and a volume (cm³) of the magnetic layer 43 in the measurement sample. Note that the volume of the magnetic layer 43 is obtained by multiplying an area of the measurement sample by the average thickness tᵢ of the magnetic layer 43. A method of calculating the average thickness tᵢ of the magnetic layer 43 necessary for calculating the volume of the magnetic layer 43 is as described above.

(Magnetic Viscosity Coefficient S)

First, a magnetic field of −1193 kA/m (15 kOe) is applied to the entire magnetic tape MT (measurement sample), and the magnetic field is returned to 0 to obtain a residual magnetization state. Thereafter, a magnetic field equivalent to the value of the residual coercive force Hr obtained from the DCD curve is applied in the opposite direction. The magnetization amount is continuously measured at regular time intervals for 1000 seconds in a state where the magnetic field is applied.

The magnetic viscosity coefficient S is calculated by comparing a relationship between time t and a magnetization amount M(t) thus obtained with the following equation.

M(t)=M0+S×ln(t)

(where M(t) is a magnetization amount at time t, M0 is an initial magnetization amount, S is a magnetic viscosity coefficient, and ln(t) is a natural logarithm of time.)

(Surface roughness R_{b} of back surface) Surface roughness R_{b} of a back surface (surface roughness of the back layer 44) preferably satisfies R_{b}≤6.0 [nm]. When the surface roughness R_{b} of the back surface is in a range described above, more excellent electromagnetic conversion characteristics can be obtained.

The surface roughness R_{b} of the back surface is obtained as follows. First, the magnetic tape MT accommodated in the cartridge 10 is unwound, and the magnetic tape MT is cut to a length of 100 mm at a position of 30 m to 40 m in the longitudinal direction from a connection portion 21 between the magnetic tape MT and the leader tape LT to prepare a sample. Next, the sample is placed on a slide glass such that a surface to be measured (surface on the side of the magnetic layer) of the sample faces upward, and an end of the sample is fixed with a mending tape. A surface shape is measured with VertScan (20× objective lens) as a measuring device, and the surface roughness R_{b} of the back surface is obtained from the following equation on the basis of the standard of ISO 25178.
Device: Non-contact roughness meter using optical interference

(Non-Contact Surface/Layer and Sectional Shape Measurement System VertScan R 5500-GL-M100AC Manufactured by Ryoka Systems Inc.)
Objective lens: 20×
Measurement region: 640×480 pixels (field of view: about 237 μm×178 μm)
Measurement mode: phase
Wavelength filter: 520 nm
CCD: ⅓ inch
Noise removal filter: Smoothing 3×3
Surface correction: Correction by second-order polynomial approximation surface
Measurement software: VS-Measure Version 5.5.2
Analysis software: VS-viewer Version 5.5.5

$${S}_{a} = \frac{1}{A} {\int }_{A} \int \vert Z ( x , y ) \vert dxdy \qquad [ Equation 2 ]$$

As described above, after the surface roughness is measured at at least five positions in the longitudinal direction of the magnetic tape MT, an average value of an arithmetic average roughness Sₐ (nm) automatically calculated from a surface profile obtained at each position is defined as the surface roughness R_{b} (nm) of the back surface.

(Young's Modulus in Longitudinal Direction of Magnetic Tape)

The Young's modulus of the magnetic tape MT in the longitudinal direction is, for example, 9.0 GPa or less, preferably 8.0 GPa or less, more preferably 7.9 GPa or less, still more preferably 7.5 GPa or less, and particularly preferably 7.1 GPa or less. When the Young's modulus of the magnetic tape MT in the longitudinal direction is 8.0 GPa or less, the stretchability of the magnetic tape MT by an external force is further enhanced, and adjustment of the width of the magnetic tape MT by tension adjustment is further facilitated. Therefore, off-track can be more appropriately suppressed, and data recorded on the magnetic tape MT can be more accurately reproduced. A lower limit value of the Young's modulus of the magnetic tape MT in the longitudinal direction is preferably 3.0 GPa or more, and more preferably 4.0 GPa or more. When the lower limit value of the Young's modulus of the magnetic tape MT in the longitudinal direction is 3.0 GPa or more, deterioration of the running stability can be suppressed.

The Young's modulus of the magnetic tape MT in the longitudinal direction is a value indicating difficulty in expansion and contraction of the magnetic tape MT in the longitudinal direction due to an external force. As this value is larger, the magnetic tape MT is less likely to expand and contract in the longitudinal direction due to the external force. As this value is smaller, the magnetic tape MT is more likely to expand and contract in the longitudinal direction due to the external force.

Note that the Young's modulus of the magnetic tape MT in the longitudinal direction is a value related to the longitudinal direction of the magnetic tape MT, but also correlated with difficulty in expansion and contraction of the magnetic tape MT in the width direction. That is, as this value is larger, the magnetic tape MT is less likely to expand and contract in the width direction by an external force, and as this value is smaller, the magnetic tape MT is more likely to expand and contract in the width direction by the external force. Therefore, in terms of tension adjustment, it is advantageous that the Young's modulus of the magnetic tape MT in the longitudinal direction is small as described above and is 8.0 GPa or less.

A tensile tester (AG-100D manufactured by SHIMADZU CORPORATION) is used to measure the Young's modulus. In a case where the Young's modulus of the tape in the longitudinal direction is to be measured, the magnetic tape MT accommodated in the cartridge 10 is unwound, and the magnetic tape MT is cut to a length of 180 mm at a position of 30 m to 40 m in the longitudinal direction from a connection portion 21 between the magnetic tape MT and the leader tape LT to prepare a measurement sample. A tool capable of fixing the width (½ inch) of the tape is attached to the tensile tester described above to fix the upper and lower sides of the tape width. A distance (tape length between chucks) is set to 100 mm. After chucking a tape sample, stress is gradually applied in a direction of pulling the sample. Tensile rate is 0.1 mm/min. From a change in stress and an amount of elongation at this time, Young's modulus is calculated by using the following equation.

E(N/m²)=((ΔN/S)/(Δx/L))×10⁶
ΔN: Change in stress (N)
S: Sectional area of test piece (mm²)
Δx: Amount of elongation (mm)
L: Distance between grip tools (mm)

A sectional area S of the measurement sample described above is a sectional area before tensile operation, and is obtained by the product of a width (½ inch) of the measurement sample and a thickness of the measurement sample. For a range of a tensile stress at the time of measurement, a range of the tensile stress in a linear region is set in accordance with the thickness of the magnetic tape MT or the like. Here, the range of the stress is set to 0.5 N to 1.0 N, and the change in stress (ΔN) and the amount of elongation (Δx) at this time are used for calculation. Note that the Young's modulus described above is measured at 25° C.±2° C. and 50% RH±5% RH.

(Young's Modulus in Longitudinal Direction of Substrate)

The Young's modulus of the substrate 41 in the longitudinal direction is, for example, 7.8 GPa or less, preferably 7.5 GPa or less, more preferably 7.4 GPa or less, still more preferably 7.0 GPa or less, and particularly preferably 6.6 GPa or less. When the Young's modulus of the substrate 41 in the longitudinal direction is 7.5 GPa or less, the stretchability of the magnetic tape MT by an external force is further enhanced, and adjustment of the width of the magnetic tape MT by tension adjustment is further facilitated. Therefore, off-track can be more appropriately suppressed, and data recorded on the magnetic tape MT can be more accurately reproduced.

The Young's modulus of the substrate 41 described above in the longitudinal direction is determined as follows. First, the magnetic tape MT accommodated in the cartridge 10 is unwound, and the magnetic tape MT is cut to a length of 180 mm at a position of 30 m to 40 m in the longitudinal direction from the connection portion 21 between the magnetic tape MT and the leader tape LT to prepare a sample. Subsequently, the underlayer 42, the magnetic layer 43, and the back layer 44 are removed from the cut magnetic tape MT to obtain the substrate 41. By using the substrate 41, the Young's modulus of the substrate 41 in the longitudinal direction is obtained in a similar procedure to the Young's modulus of the magnetic tape MT described above in the longitudinal direction. A lower limit value of the Young's modulus of the substrate 41 in the longitudinal direction is preferably 2.5 GPa or more, and more preferably 3.0 GPa or more. When the lower limit value of the Young's modulus of the substrate 41 in the longitudinal direction is 2.5 GPa or more, deterioration of the running stability can be suppressed.

A thickness of the substrate 41 occupies half or more of the thickness of the entire magnetic tape MT. Therefore, the Young's modulus of the substrate 41 in the longitudinal direction is correlated with difficulty in expansion and contraction of the magnetic tape MT due to an external force. As this value is larger, the magnetic tape MT is less likely to expand and contract in the width direction due to the external force. As this value is smaller, the magnetic tape MT is more likely to expand and contract in the width direction due to the external force.

Note that the Young's modulus of the substrate 41 in the longitudinal direction is a value related to the longitudinal direction of the magnetic tape MT, but also correlated with difficulty in expansion and contraction of the magnetic tape MT in the width direction. That is, as this value is larger, the magnetic tape MT is less likely to expand and contract in the width direction by an external force, and as this value is smaller, the magnetic tape MT is more likely to expand and contract in the width direction by the external force. Therefore, in terms of tension adjustment, it is advantageous that the Young's modulus of the substrate 41 in the longitudinal direction is small as described above and is 7.5 GPa or less.

(MSE Resistance Values of Magnetic Layer and Underlayer)

A correlation between the amount of projected particles and an erosion depth is obtained for each of the underlayer 42 and the magnetic layer 43 by a micro slurry-jet erosion (MSE) test, a calculation of a ratio (ΔM/ΔD) of a particle amount ΔM required to wear an erosion depth range ΔD to the erosion depth range is performed for each of the underlayer 42 and the magnetic layer 43 on the basis of the correlation described above, and a result of the calculation is defined as MSE resistance values R2 and R1 of the underlayer 42 and the magnetic layer 43, respectively. With such definitions, a ratio (R1/R2) (hereinafter, referred to as “MSE resistance ratio (R1/R2)”) of the MSE resistance value R1 of the magnetic layer 43 to the MSE resistance value R2 of the underlayer 42 is in a range of 0.45 or more and 0.80 or less, preferably 0.49 or more and 0.77 or less.

When the MSE resistance ratio (R1/R2) exceeds 0.80, relative hardness of the underlayer 42 against the magnetic layer 43 decreases. Thus, after repeated recording or reproduction is performed, the magnetic surface is flattened by sinking of material included in the magnetic layer 43 (for example, magnetic powder and additives (for example, antistatic agent, abrading agent, and the like)), and a real contact area between the magnetic surface and the magnetic head increases. Therefore, after repeated recording or reproduction is performed, friction of the magnetic surface is likely to increase, and the running stability is deteriorated. The deterioration of the running stability causes, for example, the tape to stick to the magnetic head. On the other hand, when the MSE resistance value ratio (R1/R2) is less than 0.45, a strength of the magnetic layer 43 against the underlayer 42 decreases, and the powder falls during sliding.

An upper limit value of the MSE resistance value R1 of the magnetic layer 43 is preferably in a range of 50.0 g/μm or less, more preferably 44.4 g/μm or less, and still more preferably 31.0 g/μm or less. When the upper limit value of the MSE resistance value R1 of the magnetic layer 43 is 50.0 g/μm or less, an appropriate path for causing the lubricant to ooze out to the magnetic surface is easily formed in the magnetic layer 43, and the lubricant is sufficiently supplied from the underlayer 42 to the magnetic layer 43. Therefore, after repeated recording or reproduction is performed, an increase in friction of the magnetic surface is suppressed, and the running stability is improved.

A lower limit value of the MSE resistance value R1 of the magnetic layer 43 is preferably 27.0 g/μm or more, and more preferably 30.1 or more. When the lower limit value of the MSE resistance value R1 of the magnetic layer 43 is 27.0 g/μm or more, the magnetic layer 43 has sufficient strength, and powder falling during sliding is suppressed.

An upper limit value of the MSE resistance value R2 of the underlayer 42 is preferably 65.0 g/μm or less, and more preferably 61.7 g/μm or less. When the upper limit value of the MSE resistance value R2 of the underlayer 42 is 65.0 g/μm or less, flexibility of the magnetic tape MT is maintained, and it is therefore possible to maintain the contact of the magnetic tape MT with the head during running.

A lower limit value of the MSE resistance value R2 of the underlayer 42 is preferably 51.0 g/μm or more, and more preferably 53.1 g/μm or more. When the lower limit value of the MSE resistance value R2 of the underlayer 42 is 51.0 g/μm or more, it is possible to suppress flattening of the magnetic surface due to sinking of the material (for example, magnetic powder and additives (for example, antistatic agent, abrading agent, and the like)) included in the magnetic layer 43. It is thus possible to suppress an increase in the real contact area between the magnetic surface and the magnetic head. Therefore, an increase in friction can be suppressed.

A method of calculating the MSE resistance values R1 and R2 and the MSE resistance ratio (R1/R2) will be described in the following order.
(1) Determination of erosion depth range for calculation of MSE resistance values R1 and R2
(2) MSE test
(3) Calculation of MSE resistance values R1 and R2 and MSE resistance ratio (R1/R2)

(1) Determination of Erosion Depth Range for Calculation of MSE Resistance Values R1 and R2

First, the average thickness tᵢ of the magnetic layer 43 is obtained by a procedure similar to the method of measuring the average thickness t₁ of the magnetic layer 43 described above. Next, by using the obtained average thickness t₁ of the magnetic layer 43, an erosion depth range ΔD1 (hereinafter, referred to as a “first erosion depth range ΔD1”) for calculating the MSE resistance value R1 of the magnetic layer 43 is determined as follows. That is, as illustrated in FIG. 3, a region corresponding to 0% or more and 70% or less of the average thickness t₁ of the magnetic layer 43 from the surface (magnetic surface) of the magnetic layer 43 toward a depth direction of the magnetic layer 43 is defined as the first erosion depth range ΔD1.

Next, a TEM image of a cross section of the underlayer 42 is obtained in a similar manner to the method of measuring the average thickness tᵢ of the magnetic layer 43 described above. However, a magnification of the TEM image is appropriately adjusted in accordance with the thickness of the underlayer 42. Next, by using the obtained TEM image of the underlayer 42, an erosion depth range ΔD2 (hereinafter, referred to as a “second erosion depth range ΔD2”) for calculating the MSE resistance value R2 of the underlayer 42 is determined as follows. That is, as illustrated in FIG. 3, a region from a position of 150 nm to a position of 250 nm in the depth direction from the surface (magnetic surface) of the magnetic layer 43 is defined as the second erosion depth range ΔD2.

(2) MSE Test

First, a square test sample having a size of 1 cm×1 cm is cut from a magnetic tape MT similar to the magnetic tape MT from which the average thicknesses t, and t₂ have been measured. A position at which the test sample is cut is in a range of 30 m to 40 m in the longitudinal direction from the connection portion 21 between the magnetic tape MT and the leader tape LT. Next, the test sample is fixed to a square SUS plate having a size of 2 cm×2 cm with Kapton (registered trademark) double-sided tape.

A device name and measurement conditions (conditions for an erosion device and conditions for a shape measurement device) of an MSE testing device used for erosion processing and shape measurement are as follows. The MSE testing device includes an erosion device that sprays slurry to a sample and a probe type shape measurement device that measures shapes of erosion marks, and is a device that performs erosion processing and shape measurement an arbitrary number of times.

<Name of Used Device>
MSE-A manufactured by Palmeso CO., Ltd.

<Conditions for Erosion Device>
Nozzle diameter: 1 mm×1 mm
Projection distance: 4 mm
Particles used: 0.3 μm polygonal alumina particles (MSE-GA03-1 manufactured by Palmeso CO., Ltd.)
Slurry concentration: 1% by mass (adjusted with pure water)
Amount of projected particles: 0.2 g/time
Projection force: 0.016 μm/g PMMA

<Conditions for Shape Measurement Device>
Tip R of probe: 2 μm
Load: 100 μN
Measurement magnification: 50000
Measurement length: 3 mm
Measurement speed: 0.2 mm/sec

For setting a projection force of an erosion device, a PMMA reference piece (manufactured by Kanase Lite, thickness: 2 mm×length: 20 mm×width: 20 mm) is used as a material for calibration. A projection pressure flow rate of a device value is set to a predetermined erosion rate.

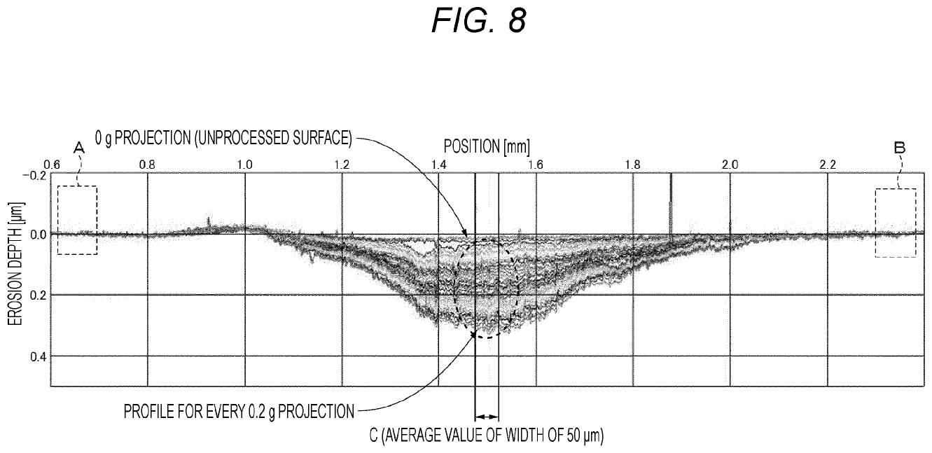

Next, the measurement sample fixed on the SUS plate is set in the MSE test device, and erosion processing and shape measurement are performed N times until the erosion depth exceeds the second erosion depth range ΔD2, and shape measurement data (profile of erosion marks) for N times is acquired. FIG. 8 is a graph illustrating an example of the profile of erosion marks for N times.

(3) Calculation of MSE Resistance Values R1 and R2 and MSE Resistance Ratio (R1/R2)

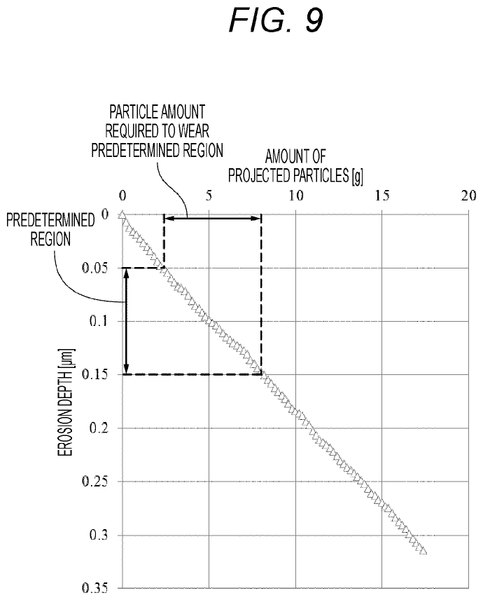

First, a graph showing a correlation between the amount of projected particles and the erosion depth (hereinafter, referred to as an “erosion progress graph”) is manually created as follows. The erosion depth is acquired from the acquired shape measurement data. Inclination correction is performed by using both end reference areas A and B that are not worn in a measurement length. After the correction, a step from a regression line as a reference to a wear mark central portion C (average value of a width of 50 μm) is measured. After the measurement, a difference between step data at 0 g projection (unprocessed surface) and the step data at each projection amount is obtained, and the erosion depth is acquired. An erosion progress graph is created from the acquired projection amount and erosion depth data. FIG. 9 illustrates an example of the erosion progress graph.

Next, a calculation of a ratio (ΔM1/ΔD1) of a particle amount ΔM1 required to wear the first erosion depth range ΔD1 described above to the first erosion depth range ΔD1 described above is performed from the created erosion progress graph, and a result of the calculation is defined as the MSE resistance value R1 of the magnetic layer 43. Furthermore, from the created erosion progress graph, a calculation of a ratio (ΔM2/ΔD2) of a particle amount ΔM2 required to wear the second erosion depth range (2) described above to the second erosion depth range ΔD2 described above is performed, and a result of the calculation is defined as the MSE resistance value R2 of the underlayer 42.

Next, by using the calculated MSE resistance values R1 and R2, the MSE resistance ratio (R1/R2), that is, the ratio (R1/R2) of the MSE resistance value R1 of the magnetic layer 43 to the MSE resistance value R2 of the underlayer 42 is calculated.

(MSE Resistance Value of Back Layer)

A correlation between the amount of projected particles and the erosion depth is obtained in the back layer 44 by the MSE test, a calculation of a ratio of the particle amount required to wear an erosion depth range to the erosion depth range is performed on the basis of the correlation described above, and a result of the calculation is defined as an MSE resistance value R3 of the back layer 44. With such definitions, the MSE resistance value R3 of the back layer 44 is preferably larger than the MSE resistance value R1 of the magnetic layer 43. When the MSE resistance value R3 of the back layer 44 is larger than the MSE resistance value R1 of the magnetic layer 43, the back layer 44 can be made harder than the magnetic layer 43, and it is thus possible to suppress wear of the back layer 44 due to unwinding and winding of the magnetic tape MT. It is therefore possible to suppress abrasion powder from adhering to the magnetic layer 43.

(Dynamic friction coefficient) In a case where a coefficient of dynamic friction between the surface of the magnetic layer 43 and the magnetic head 56 when a tension applied to the magnetic tape MT is 0.6 N is p, a friction coefficient ratio (μ(1000)/μ(10)) of a dynamic friction coefficient μ(1000) in 1000th running to a dynamic friction coefficient μ(10) in 10th running is preferably 1.0 or more and 1.4 or less, more preferably 1.0 or more and 1.3 or less, and still more preferably 1.0 or more and 1.2 or less. When the friction coefficient ratio (μ(1000)/μ(10)) is 1.0 or more and 1.4 or less, a change in the dynamic friction coefficient after 1000 times of running can be reduced, and thus deterioration in the running stability can be suppressed even after 1000 times of running. Here, a magnetic head for a drive corresponding to the magnetic tape MT is used as the magnetic head 56.

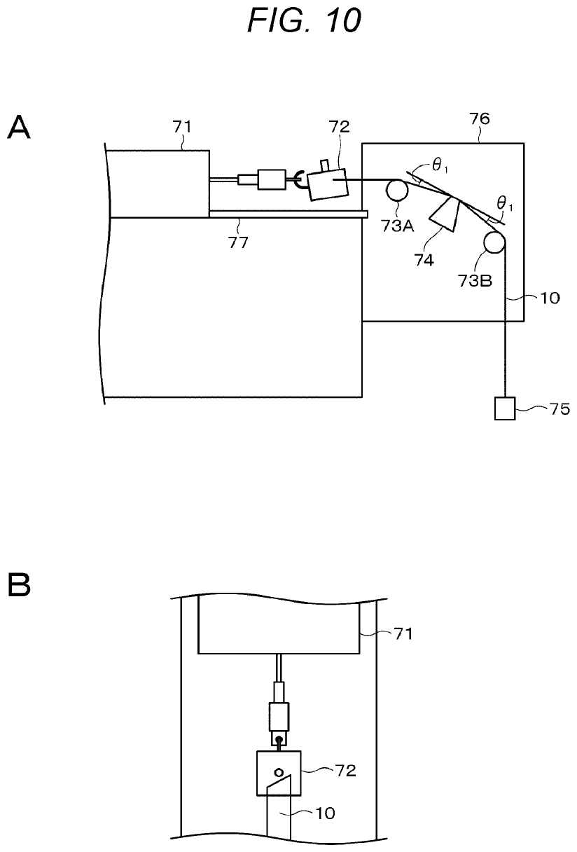

The dynamic friction coefficient μ(10) and the dynamic friction coefficient μ(1000) for calculating the friction coefficient ratio (μ(1000)/μ(10)) are obtained as follows. First, the magnetic tape MT accommodated in the cartridge 10 is unwound, and the magnetic tape MT having a ½ inch width is cut to a length of 250 mm at a position of 30 m to 40 m in the longitudinal direction from the connection portion 21 between the magnetic tape MT and the leader tape LT to prepare a sample. Next, as illustrated in FIG. 10A, the magnetic tape MT having a ½ inch width is placed on two cylindrical guide rolls 73A and 73B having a 1 inch diameter, which are arranged in parallel to be spaced apart from each other, such that the magnetic surface is in contact with the guide rolls 73A and 73B. The two guide rolls 73A and 73B are fixed to a hard plate member 76, and thus a mutual positional relationship is fixed.

Next, the magnetic surface of the magnetic tape MT is brought into contact with a head block (for recording and reproducing) 74 mounted in an LTO 5 drive such that a wrap angle θ₁ (°)=20°. The head block 74 is disposed substantially at a center of the guide rolls 73A and 73B. The head block 74 is movably attached to the plate member 76 so as to change the wrap angle θ₁, but when the holding angle θ₁ (°) becomes 20°, that position is fixed to the plate member 76, and therefore, a positional relationship between the guide rolls 73A and 73B and the head block 74 is also fixed.

One end of the magnetic tape MT is connected to a movable strain gauge 71 via a jig 72. The magnetic tape MT is fixed to the jig 72 as illustrated in FIG. 10B. A weight 75 is connected to the other end of the magnetic tape MT. A tension (T₀[N]) of 0.6 N is applied by the weight 75 in the longitudinal direction of the magnetic tape MT. The movable strain gauge 71 is fixed on a board 77. A positional relationship between the board 77 and the plate member 76 is also fixed, and therefore, a positional relationship between the guide rolls 73A and 73B, the head block 74, and the movable strain gauge 71 is fixed.

The movable strain gauge 71 slides the magnetic tape MT by 5 cm on the head block 74 so that the magnetic tape MT moves toward the movable strain gauge 71 at a sliding speed of 1 cm/s. An output value (voltage) of the movable strain gauge 71 at the time of sliding is converted into T [N] on the basis of a linear relationship (described later) between an output value and a load acquired in advance. Tₐᵥₑ [N] is obtained by acquiring 13 times of T [N] from a start of sliding to an end of sliding for the 5 cm slide described above and simply averaging 11 times of T [N] excluding the first and last two times in total. Note that the measurement environment is maintained at 23° C.±2° C. and 45% Rh±5% Rh.

Thereafter, the dynamic friction coefficient μ (10) is obtained by the following equation.

$$μ ( 10 ) = \frac{1}{( {θ}_{1} [ ° ] ) \times ( π / 180 )} \times ln ( \frac{{T}_{ave} [ N ]}{{T}_{0} [ N ]} ) \qquad [ Equation 3 ]$$

The linear relationship described above is obtained as follows. That is, an output value (voltage) of the movable strain gauge 71 is obtained for each of a case where a load of 0.4 N is applied to the movable strain gauge and a case where a load of 1.5 N is applied to the movable strain gauge 71. The linear relationship between the output value and the load is obtained from the two obtained output values and two loads described above. By using the linear relationship, the output value (voltage) from the movable strain gauge 71 at the time of sliding is converted into T [N] as described above.

Moreover, the dynamic friction coefficient μ(1000) is obtained in a similar manner to the dynamic friction coefficient μ(10) except that the 1000th forward path measurement is performed.

From the dynamic friction coefficient μ(10) and the dynamic friction coefficient μ(1000) measured as described above, the friction coefficient ratio μ(1000)/μ(10) is calculated.

[4. Method for Manufacturing Magnetic Tape]

Next, an example of a method of manufacturing the magnetic tape MT having the above configuration will be described.

(Coating Material Preparation Step)

First, a coating material for forming the underlayer is prepared by kneading and dispersing a nonmagnetic powder, a binder, and the like in a solvent. Next, a coating material for forming the magnetic layer is prepared by kneading and dispersing a magnetic powder, a binder, and the like in a solvent. For the preparation of the coating material for forming the magnetic layer and the coating material for forming the underlayer, for example, the following solvents, dispersing devices, and kneading devices can be used.

Examples of the solvent used for preparing the above coating material include ketone-based solvents such as acetone, methyl ethyl ketone, methyl isobutyl ketone, and cyclohexanone, alcohol-based solvents such as methanol, ethanol, and propanol, ester-based solvents such as methyl acetate, ethyl acetate, butyl acetate, propyl acetate, ethyl lactate, and ethylene glycol acetate, ether-based solvents such as diethylene glycol dimethyl ether, 2-ethoxyethanol, tetrahydrofuran, and dioxane, aromatic hydrocarbon-based solvents such as benzene, toluene, and xylene, halogenated hydrocarbon-based solvents such as methylene chloride, ethylene chloride, carbon tetrachloride, chloroform, and chlorobenzene, and the like. These may be used alone or in an appropriate mixture.

As the kneading device used for preparing the above coating material, for example, a kneading device such as a continuous biaxial kneader, a continuous biaxial kneader capable of diluting in multiple stages, a kneader, a pressure kneader, or a roll kneader can be used, but the kneading device is not limited to these devices. In addition, as the dispersing device used for preparing the above coating material, for example, a dispersing device such as a roll mill, a ball mill, a horizontal sand mill, a vertical sand mill, a spike mill, a pin mill, a tower mill, a pearl mill (for example, “DCP mill” manufactured by Eirich Co., Ltd.), a homogenizer, or an ultrasonic dispersing machine can be used, but the dispersing device is not limited to these devices.

In a step of preparing the coating material described above for forming the magnetic layer, the MSE resistance ratio (R1/R2) can be set in a range of 0.45 or more and 0.80 or less by adjusting a ratio (mass ratio) of a compounding amount of the magnetic powder to a compounding amount of the binder (hereinafter, referred to as a “P/B ratio”). When the P/B ratio of the magnetic layer 43 increases, the strength of the magnetic layer 43 decreases, and the MSE resistance ratio (R1/R2) tends to decrease. On the other hand, when the P/B ratio of the magnetic layer 43 decreases, the strength of the magnetic layer 43 increases, and the MSE resistance ratio (R1/R2) tends to increase.

(Application Step)

Next, the coating material for forming the underlayer is applied to one main surface of the substrate 41 and dried to form the underlayer 42. Subsequently, the coating material for forming the magnetic layer is applied to the underlayer 42 and dried to form the magnetic layer 43 on the underlayer 42. Note that, at a time of drying, the magnetic powder is oriented in the thickness direction of the substrate 41 by a magnetic field by using, for example, solenoidal coil. Furthermore, at the time of drying, the magnetic powder may be oriented in the running direction (longitudinal direction) of the substrate 41 by a magnetic field by using, for example, solenoidal coil, and then be oriented in the thickness direction of the substrate 41 of the substrate 41 by a magnetic field. By performing processing of once orienting the magnetic powder in the longitudinal direction in this manner, the degree of vertical orientation (that is, the squareness ratio Si) of the magnetic powder can be further improved. After the magnetic layer 43 is formed, the back layer 44 is formed on the other main surface of the substrate 41. As a result, the magnetic tape MT is obtained.

The squareness ratios S1 and S2 are set to desired values by, for example, adjusting a strength of the magnetic field applied to a coating film of the coating material for forming the magnetic layer, a concentration of solid content in the coating material for forming the magnetic layer, and drying conditions (drying temperature and drying time) of a coating film of the coating material for forming the magnetic layer. The strength of the magnetic field applied to the coating film is preferably not less than two times and not more than three times the coercive force of the magnetic powder. In order to further increase the squareness ratio S1 (that is, in order to further decrease the squareness ratio S2), it is preferable to improve the dispersion state of the magnetic powder in the coating material for forming the magnetic layer. Furthermore, in order to further increase the squareness ratio S1, it is also effective to magnetize the magnetic powder before the coating material for forming the magnetic layer enters an orientation device for orienting the magnetic powder in a magnetic field. Note that the above methods of adjusting the squareness ratios S1 and S2 described above may be used alone or in combination of two or more.

(Curing Step)

After the magnetic tape MT is wound into a roll shape, the magnetic tape MT is subjected to a heating treatment in this state to cure the underlayer 42 and the magnetic layer 43.

(Calendering Step)

Next, the obtained magnetic tape MT is calendered to smooth the surface of the magnetic layer 43.

(Cutting Step)

Next, the magnetic tape MT is cut into a predetermined width (for example, ½ inch width). As a result, the magnetic tape MT is obtained.

(Demagnetization Step and Servo Pattern Writing Step)

Next, after demagnetizing the magnetic tape MT as necessary, a servo pattern may be written on the magnetic tape MT.

[5. Operation and Effect]

As described above, in the magnetic tape MT according to one embodiment, since the MSE resistance ratio (R1/R2) is 0.80 or less, the lubricant is sufficiently supplied from the underlayer 42 to the magnetic layer 43, and it is possible to suppress an increase in friction of the magnetic surface even after repeated recording or reproduction is performed. Therefore, deterioration of the running stability can be suppressed. In addition, since the MSE resistance ratio (R1/R2) is 0.45 or more, a decrease in the strength of the magnetic layer 43 can be suppressed. Therefore, powder falling during sliding of the magnetic tape MT can be suppressed.

[6. Modification]

In the above one embodiment, a case where the magnetic tape cartridge is the cartridge 10 with one reel has been described, but the magnetic tape cartridge may be a cartridge with two reels.

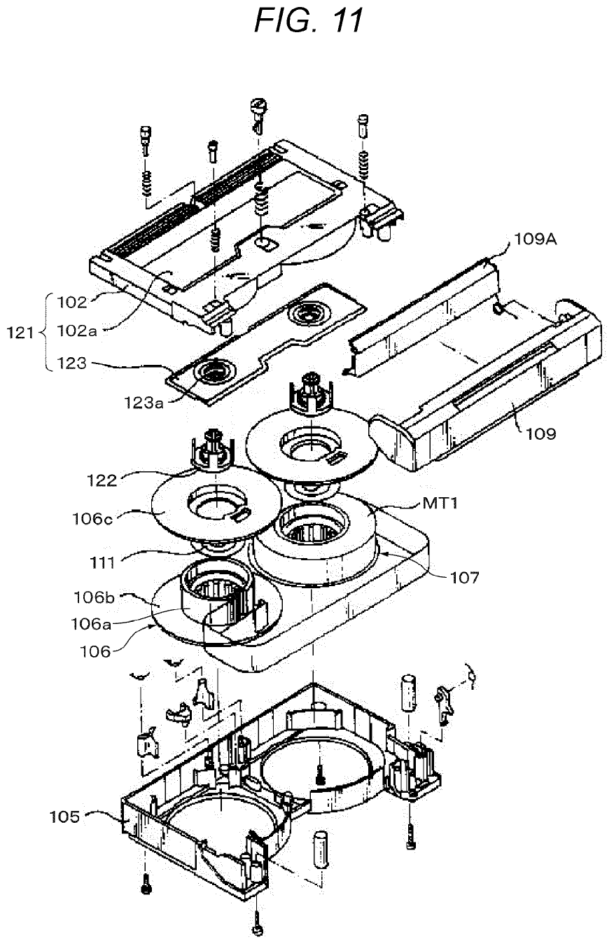

FIG. 11 is an exploded perspective view illustrating an example of a configuration of a cartridge 121 with two reels. The cartridge 121 includes an upper half 102 including a synthetic resin, a transparent window member 123 fitted and fixed to a window 102a opened in an upper surface of the upper half 102, a reel holder 122 fixed to an inner side of the upper half 102 and preventing uplift of reels 106 and 107, a lower half 105 corresponding to the upper half 102, the reels 106 and 107 stored in a space formed by combining the upper half 102 and the lower half 105, a magnetic tape MT1 wound around the reels 106 and 107, a front lid 109 closing a front side opening formed by combining the upper half 102 and the lower half 105, and a back lid 109A protecting the magnetic tape MT1 exposed to the front side opening.

The reels 106 and 107 are for winding the magnetic tape MT. The reel 106 includes a lower flange 106b having a cylindrical hub portion 106a around which the magnetic tape MT1 is wound in a center, an upper flange 106c having substantially the same size as the lower flange 106b, and a reel plate 111 sandwiched between the hub portion 106a and the upper flange 106c. The reel 107 has a similar configuration to the reel 106.

The window member 123 is provided with attachment holes 123a at positions corresponding to the reels 106 and 107, respectively, for assembling a reel holder 122 as a reel holding means for preventing the reel from being lifted up. The magnetic tape MT1 is similar to the magnetic tape MT in the first embodiment.

### EXAMPLES

Hereinafter, the present disclosure will be specifically described with reference to Examples, but the present disclosure is not limited to Examples.

In the following Examples and Comparative Examples, the average aspect ratio of the magnetic powder, the average particle volume of the magnetic powder, the average thickness of the magnetic layer, the average thickness of the underlayer, the average thickness of the substrate (base film), the average thickness of the back layer, the average thickness of the magnetic tape, the squareness ratio Si of the magnetic layer in the perpendicular direction of the magnetic tape, and the squareness ratio S2 of the magnetic layer in the longitudinal direction of the magnetic tape are values obtained by the measurement methods described in the above one embodiment.

### Example 1

(Step of Preparing Coating Material for Forming Magnetic Layer)

A coating material for forming a magnetic layer was prepared as follows. First, a first composition having the following formulation was kneaded with an extruder. Next, the kneaded first composition and a second composition having the following formulation were added to a stirring tank equipped with a disper, and premixing was performed. Subsequently, sand mill mixing was further performed, and a filter treatment was performed to prepare the coating material for forming the magnetic layer. At this time, the compounding amounts of the magnetic powder and the binder were set so that the P/B ratio was 5.0.

(First Composition)
Barium ferrite (BaFe₁₂O₁₉) magnetic powder (hexagonal plate shape, average aspect ratio 3.2, average particle volume 2500 nm³): 100 parts by mass
Vinyl chloride-based resin (cyclohexanone solution 30% by mass): 66.7 parts by mass (including solution)
(Polymerization degree 300, Mn=10,000, OSO₃K=0.07 mmol/g and secondary OH=0.3 mmol/g are contained as polar groups.)
Medium particle size aluminum oxide powder: 5 parts by mass
(α-Al₂O₃, average particle diameter (D50) 0.09 μm)

(Second Composition)
Vinyl chloride-based resin: 1.1 parts by mass
(Resin solution: resin content 30% by mass, cyclohexanone 70% by mass)
n-butyl stearate: 2 parts by mass
Methyl ethyl ketone: 121.3 parts by mass
Toluene: 121.3 parts by mass
Cyclohexanone: 60.7 parts by mass
Carbon black: 2 parts by mass
(Trade name: Seast TA, manufactured by TOKAI CARBON CO., LTD.)

Finally, 4 parts by mass of polyisocyanate (trade name: Coronate L, manufactured by Tosoh Corporation) as a curing agent and 2 parts by mass of stearic acid as a lubricant were added to the coating material for forming the magnetic layer prepared as described above.

(Step of Preparing Coating Material for Forming Underlayer)

A coating material for forming an underlayer was prepared as follows. First, a third composition having the following formulation was kneaded with an extruder. Next, the kneaded third composition and a fourth composition having the following formulation were added to a stirring tank equipped with a disper, and premixing was performed. Subsequently, sand mill mixing was further performed, and a filter treatment was performed to prepare the coating material for forming the underlayer.

(Third Composition)
Needle iron oxide powder having a medium particle diameter (nonmagnetic powder): 100 parts by mass
(α-Fe₂O₃, average long axis length 0.08 μm)
Vinyl chloride-based resin: 55.6 parts by mass
(Resin solution: resin content 30% by mass, cyclohexanone 70% by mass)
Carbon black: 10 parts by mass
(Average particle diameter 20 nm)

(Fourth Composition)
Polyurethane-based resin UR8200 (manufactured by TOYOBO CO., LTD.): 18.5 parts by mass
n-butyl stearate: 2 parts by mass
Methyl ethyl ketone: 108.2 parts by mass
Toluene: 108.2 parts by mass
Cyclohexanone: 18.5 parts by mass

Finally, 4.0 parts by mass of polyisocyanate (trade name: Coronate L, manufactured by Tosoh Corporation) as a curing agent and 2.0 parts by mass of stearic acid as a lubricant were added to the coating material for forming the underlayer prepared as described above.

(Step of Preparing Coating Material for Forming Back Layer)

A coating material for forming a back layer was prepared as follows. The following raw materials were mixed in a stirring tank equipped with a disper and subjected to a filter treatment to prepare the coating material for forming the back layer.
Carbon black powder (average particle diameter (D50) 20 nm): 100 parts by mass
Polyester polyurethane: 100 parts by mass
(Trade name: N-2304, manufactured by Nippon Polyurethane Industry Co., Ltd.)
Methyl ethyl ketone: 500 parts by mass
Toluene: 400 parts by mass
Cyclohexanone: 100 parts by mass

(Application Step)

By using the coating material for forming the magnetic layer and the coating material for forming the underlayer prepared as described above, an underlayer and a magnetic layer were formed as follows on one main surface of an elongated polyethylene naphthalate film (hereinafter, referred to as a “PEN film”) having an average thickness of 3.6 μm as a substrate. First, the coating material for forming the underlayer was applied to one main surface of the PEN film and dried to form the underlayer so that the average thickness was 0.8 μm after the calendering treatment. Next, the coating material for forming the magnetic layer was applied to the underlayer and dried to form a magnetic layer so that the average thickness was 0.07 μm after the calendering treatment. Note that when the coating material for forming the magnetic layer was dried, the magnetic powder was oriented by a magnetic field in a thickness direction of the film by solenoid coil. In addition, the squareness ratio Si of the magnetic tape in the perpendicular direction (thickness direction) was set to 65%, and the squareness ratio S2 of the magnetic tape in the longitudinal direction was set to 38%. Subsequently, the coating material for forming the back layer was applied to the other main surface of the PEN film and dried to form the back layer so that the average thickness was 0.4 μm after the calendering treatment. As a result, the magnetic tape is obtained.

(Curing Step)

After the magnetic tape was wound into a roll, the magnetic tape was subjected to a heating treatment at 70° C. for 48 hours in this state to cure the underlayer and the magnetic layer.

(Calendering Step)

The calendering treatment was performed to smooth the surface of the magnetic layer. At this time, temperature for the calendering was 100° C., and pressure for the calendering was 200 kg/cm.

(Cutting Step)

The magnetic tape obtained as described above was cut into a width of ½ inches (12.65 mm). As a result, the magnetic tape having the average thickness of 4.87 μm is obtained.

### Example 2

A magnetic tape was obtained in a similar manner to Example 1 except that the average thickness of the PEN film was 4.0 μm, the average thickness of the underlayer was 0.6 μm, and the average thickness of the magnetic tape was 5.07 μm.

### Example 3

The P/B ratio was set to 7.5 by changing the compounding amount of the vinyl chloride-based resin from 10.0 parts by mass to 6.7 parts by mass and changing the compounding amount of the urethane-based resin from 10.0 parts by mass to 6.7 parts by mass. In addition, the compounding amount of the polyisocyanate as a curing agent was changed from 4.0 parts by mass to 2.7 parts by mass in accordance with the change in the amount of the binder described above. A magnetic tape was obtained in a similar manner to Example 2 except for the above.

### Example 4

The P/B ratio was set to 8.0 by changing the compounding amount of the vinyl chloride-based resin from 10.0 parts by mass to 6.3 parts by mass and changing the compounding amount of the urethane-based resin from 10.0 parts by mass to 6.3 parts by mass. In addition, the compounding amount of the polyisocyanate as a curing agent was changed from 4.0 parts by mass to 2.5 parts by mass in accordance with the change in the amount of the binder described above. A magnetic tape was obtained in a similar manner to Example 1 except for the above.

### Comparative Example 1

The P/B ratio was set to 4.0 by changing the compounding amount of the vinyl chloride-based resin from 10.0 parts by mass to 12.5 parts by mass and changing the compounding amount of the urethane-based resin from 10.0 parts by mass to 12.5 parts by mass. In addition, the compounding amount of the polyisocyanate as a curing agent was changed from 4.0 parts by mass to 5.0 parts by mass in accordance with the change in the amount of the binder described above. A magnetic tape was obtained in a similar manner to Example 1 except for the above.

### Comparative Example 2

The P/B ratio was set to 8.5 by changing the compounding amount of the vinyl chloride-based resin from 10.0 parts by mass to 5.9 parts by mass and changing the compounding amount of the urethane-based resin from 10.0 parts by mass to 5.9 parts by mass. In addition, the compounding amount of the polyisocyanate as a curing agent was changed from 4.0 parts by mass to 2.4 parts by mass in accordance with the change in the amount of the binder described above. A magnetic tape was obtained in a similar manner to Example 1 except for the above.

[Evaluation]

(MSE Resistance Values and MSE Resistance Ratio)

The MSE resistance value R1 of the magnetic layer, the MSE resistance value R2 of the underlayer, and the MSE resistance ratio (R1/R2) were evaluated by the measurement method described in the above one embodiment.

(Friction Coefficient Ratio)

The friction coefficient ratio (μ (1000)/μ (10)) of the magnetic tape was evaluated by the measurement method described in the above one embodiment.

(Presence or Absence of Powder Falling)

After running the magnetic tape, the head block after running was observed with an optical microscope (magnification: four times), and presence or absence of substances adhered to (powder falling from) the head block was visually determined.

Table 1 shows configurations and evaluation results of the magnetic tapes of Example 1 to 4 and Comparative Examples 1 and 2.

TABLE 1

| | Example | Example | Example | Example | Comparative | Comparative |
|---|---|---|---|---|---|---|
| | 1 | 2 | 3 | 4 | Example 1 | Example 2 |
| P/B ratio of magnetic | 5.0 | 5.0 | 7.5 | 8.0 | 4.0 | 8.5 |
| layer | | | | | | |
| Average thickness of | 0.07 | 0.07 | 0.07 | 0.07 | 0.07 | 0.07 |
| magnetic layer [μm] | | | | | | |
| Average thickness of | 0.8 | 0.6 | 0.6 | 0.8 | 0.6 | 0.8 |
| underlayer [μm] | | | | | | |
| Average thickness of | 3.6 | 4.0 | 4.0 | 3.6 | 4.0 | 3.6 |
| substrate [μm] | | | | | | |
| Average thickness of | 0.4 | 0.4 | 0.4 | 0.4 | 0.4 | 0.4 |
| back layer [μm] | | | | | | |
| Average thickness of | 4.87 | 5.07 | 5.07 | 4.87 | 5.07 | 4.87 |
| tape [μm] | | | | | | |
| MSE resistance value | 44.4 | 37.7 | 32.9 | 30.1 | 51.1 | 26.3 |
| R1 of magnetic layer | | | | | | |
| [g/μm] | | | | | | |
| MSE resistance value | 57.7 | 53.1 | 60.3 | 61.7 | 60.4 | 61.3 |
| R2 of underlayer | | | | | | |
| [g/μm] | | | | | | |
| MSE resistance ratio | 0.77 | 0.71 | 0.55 | 0.49 | 0.85 | 0.43 |
| (R1/R2) | | | | | | |
| Friction coefficient | 1.04 | 1.22 | 1.12 | 1.21 | 1.48 | 1.39 |
| ratio (μ(1000)/μ(10)) | | | | | | |
| Presence or absence of | absent | absent | absent | absent | absent | present |
| powder falling | | | | | | |

P/B ratio: ratio (mass ratio) of compounding amount P of magnetic powder to compounding amount B of binder

Table 1 shows the following.

When the MSE resistance ratio (R1/R2) exceeds 0.80, the friction coefficient ratio increases. Therefore, after repeated recording or reproduction is performed, the running stability is deteriorated. On the other hand, when the MSE resistance ratio (R1/R2) is less than 0.45, an increase in the friction coefficient ratio is suppressed, but powder falls during sliding.

Although the embodiment and modification of the present disclosure have been specifically described above, the present disclosure is not limited to the above embodiment and modification, and various changes based on the technical idea of the present disclosure can be made. For example, the configurations, methods, steps, shapes, materials, numerical values, and the like described in the above embodiment and modification are merely examples, and different configurations, methods, steps, shapes, materials, numerical values, and the like may be used as necessary. The configurations, methods, steps, shapes, materials, numerical values, and the like of the above embodiment and modification can be combined with each other without departing from the gist of the present disclosure.

The chemical formulas of the compounds and the like exemplified in the above embodiment and modification are representative, and are not limited to the described valences and the like as long as having common names of the same compounds. In the numerical ranges described in stages in the above embodiment and modification, the upper limit value or the lower limit value of the numerical range of a certain stage may be replaced with the upper limit value or the lower limit value of the numerical range of another stage. The materials exemplified in the above embodiment and modification can be used alone or in combination of two or more unless otherwise specified.

Furthermore, the present disclosure can adopt the following configurations.

(1) A magnetic recording medium having a tape shape includes a substrate, an underlayer provided on one surface of the substrate and including a magnetic powder and a binder, and a magnetic layer provided on the underlayer and including a nonmagnetic powder, a binder, and a lubricant, in which the magnetic recording medium has an average thickness of 5.3 μm or less, and in a case where a correlation between an amount of projected particles and an erosion depth is obtained in each of the underlayer and the magnetic layer by a micro slurry-jet erosion (MSE) test, a calculation of a ratio of a particle amount required to wear an erosion depth range to the erosion depth range is performed in each of the underlayer and the magnetic layer on the basis of the correlation, and a result of the calculation is defined as an MSE resistance value of each of the underlayer and the magnetic layer, a ratio of the MSE resistance value of the magnetic layer to the MSE resistance value of the underlayer is in a range of 0.45 or more and 0.80 or less.

(2) In the magnetic recording medium according to (1), in relation to a dynamic friction coefficient μ between a surface of the magnetic layer and a magnetic head when a tension applied to the magnetic recording medium is 0.6 N, a friction coefficient ratio (μ(1000)/μ(10)) of a value μ(1000) in 1000th running to a dynamic friction coefficient μ(10) in 10th running is 1.0 or more and 1.4 or less.

(3) In the magnetic recording medium according to (1) or (2), the ratio of the MSE resistance value of the magnetic layer to the MSE resistance value of the underlayer is in a range of 0.49 or more and 0.77 or less.

(4) In the magnetic recording medium according to any of (1) to (3), the MSE resistance value of the magnetic layer is 44.4 g/μm or less.

(5) In the magnetic recording medium according to any of (1) to (4), the MSE resistance value of the magnetic layer is 31.0 g/μm or less.

(6) In the magnetic recording medium according to any of (1) to (5), the MSE resistance value of the underlayer is 65.0 g/μm or less.

(7) In the magnetic recording medium according to any of (1) to (6), the MSE resistance value of the underlayer is 51.0 g/μm or more and 65.0 g/μm or less. (8) The magnetic recording medium according to any of (1) to (7) further includes a back layer provided on an another surface of the substrate, in which in a case where a correlation between an amount of projected particles and an erosion depth is obtained in the back layer by a micro slurry-jet erosion (MSE) test, a calculation of a ratio of a particle amount required to wear an erosion depth range to the erosion depth range is performed on the basis of the correlation, and a result of the calculation is defined as an MSE resistance value of the back layer, the back layer has an MSE resistance value that is larger than the MSE resistance value of the magnetic layer.

(9) In the magnetic recording medium according to (8), the back layer includes a carbon powder, a binder, and a curing agent.

(10) In the magnetic recording medium according to any of (1) to (9), the substrate has an average thickness of 4.4 μm or less.

(11) In the magnetic recording medium according to any of (1) to (10), the substrate has an average thickness of 3.8 μm or less.

(12) In the magnetic recording medium according to any of (1) to (11), the substrate has an average thickness of 3.4 μm or less.

(13) In the magnetic recording medium according to any of (1) to (12), the magnetic layer has an average thickness of 80 nm or less.

(14) In the magnetic recording medium according to any of (1) to (13), the magnetic layer has an average thickness of 70 nm or less.

(15) In the magnetic recording medium according to any of (1) to (14), the magnetic layer has an average thickness of 50 nm or less.

(16) In the magnetic recording medium according to any of (1) to (15), the underlayer has an average thickness of 0.3 μm or more and 1.0 μm or less.

(17) The magnetic recording medium according to any of (1) to (16) has an average thickness of 5.0 μm or less.

(18) The magnetic recording medium according to any of (1) to (17) has an average thickness of 4.4 μm or less.

(19) In the magnetic recording medium according to any of (1) to (18), the magnetic layer in a perpendicular direction of the magnetic recording medium has a squareness ratio of 65% or more.

(20) In the magnetic recording medium according to any of (1) to (19), a squareness ratio of the magnetic recording medium in the perpendicular direction is 70% or more.

(21) In the magnetic recording medium according to any of (1) to (20), the squareness ratio of the magnetic recording medium in the perpendicular direction is 75% or more.

(22) In the magnetic recording medium according to any of (1) to (21), the squareness ratio of the magnetic recording medium in the perpendicular direction is 80% or more.

(23) In the magnetic recording medium according to any of (1) to (22), the squareness ratio of the magnetic recording medium in the perpendicular direction is 85% or more.

(24) In the magnetic recording medium according to any of (1) to (23), the magnetic powder has an average particle volume of 500 nm³ or more and 2500 nm³ or less.

(25) In the magnetic recording medium according to any of (1) to (24), the magnetic powder has an average particle volume of 500 nm³ or more and 1600 nm³ or less.

(26) In the magnetic recording medium according to any of (1) to (25), the magnetic powder has an average particle volume of 500 nm³ or more and 1500 nm³ or less.

(27) In the magnetic recording medium according to any of (1) to (26), the magnetic powder includes hexagonal ferrite, ε iron oxide, or Co-containing spinel ferrite.

(28) In the magnetic recording medium according to any of (1) to (27), the magnetic layer has five or more servo bands.

(29) In the magnetic recording medium according to any of (1) to (28), the magnetic layer has nine or more servo bands.

(30) In the magnetic recording medium according to (28), a ratio of a total area of the five or more servo bands to an area of a surface of the magnetic layer is 4.0% or less.

(31) In the magnetic recording medium according to any of (28) to (30), the servo band has a width of 95 μm or less.

(32) In the magnetic recording medium according to any of (1) to (31), the magnetic layer is configured to form a plurality of data tracks, and the data track has a width of 2000 nm or less.

(33) In the magnetic recording medium according to any of (1) to (32), the substrate includes a polyester.

(34) A cartridge includes the magnetic recording medium according to any of (1) to (33).

(35) The cartridge according to (34) includes one or two reels around which the magnetic recording medium is wound.

### REFERENCE SIGNS LIST

10 Cartridge
11 Cartridge memory
31 Antenna coil
32 Rectification-power supply circuit
33 Clock circuit
34 Detection-modulation circuit
35 Controller
36 Memory
36A First storage region
36B Second storage region
41 Substrate
42 Underlayer
43 Magnetic layer
44 Back layer
56 Magnetic head
56A, 56B Servo lead head
110 Servo frame
111 Servo frame 1
111A A burst
111B B burst
112 Servo subframe 2
112C C burst
112D D burst
113 Servo stripe
MT Magnetic tape
SB Servo band
DB Data bind

1. A magnetic recording medium having a tape shape, the magnetic recording medium comprising:
a substrate;
an underlayer provided on one surface of the substrate and including a magnetic powder and a binder; and
a magnetic layer provided on the underlayer and including a nonmagnetic powder, a binder, and a lubricant, wherein
the magnetic recording medium has an average thickness of 5.3 μm or less, and
in a case where a correlation between an amount of projected particles and an erosion depth is obtained in each of the underlayer and the magnetic layer by a micro slurry-jet erosion (MSE) test, a calculation of a ratio of a particle amount required to wear an erosion depth range to the erosion depth range is performed in each of the underlayer and the magnetic layer on a basis of the correlation, and a result of the calculation is defined as an MSE resistance value of each of the underlayer and the magnetic layer,
a ratio of the MSE resistance value of the magnetic layer to the MSE resistance value of the underlayer is in a range of 0.45 or more and 0.80 or less.

2. The magnetic recording medium according to claim 1, wherein in relation to a dynamic friction coefficient μ between a surface of the magnetic layer and a magnetic head when a tension applied to the magnetic recording medium is 0.6 N, a friction coefficient ratio (μ(1000)/μ(10)) of a value μ(1000) in 1000th running to a dynamic friction coefficient μ(10) in 10th running is 1.0 or more and 1.4 or less.

3. The magnetic recording medium according to claim 1, wherein the ratio of the MSE resistance value of the magnetic layer to the MSE resistance value of the underlayer is in a range of 0.49 or more and 0.77 or less.

4. The magnetic recording medium according to claim 1, wherein the MSE resistance value of the magnetic layer is 44.4 g/μm or less.

5. The magnetic recording medium according to claim 1, wherein the MSE resistance value of the magnetic layer is 31.0 g/μm or less.

6. The magnetic recording medium according to claim 1, wherein the MSE resistance value of the underlayer is 65.0 g/μm or less.

7. The magnetic recording medium according to claim 1, wherein the MSE resistance value of the underlayer is 51.0 g/μm or more and 65.0 g/μm or less.

8. The magnetic recording medium according to claim 1, further comprising a back layer provided on an another surface of the substrate, wherein
in a case where a correlation between an amount of projected particles and an erosion depth is obtained in the back layer by a micro slurry-jet erosion (MSE) test, a calculation of a ratio of a particle amount required to wear an erosion depth range to the erosion depth range is performed on a basis of the correlation, and a result of the calculation is defined as an MSE resistance value of the back layer,
the back layer has an MSE resistance value that is larger than the MSE resistance value of the magnetic layer.

9. The magnetic recording medium according to claim 8, wherein the back layer includes a carbon powder, a binder, and a curing agent.

10. The magnetic recording medium according to claim 1, wherein the substrate has an average thickness of 4.4 μm or less.

11. The magnetic recording medium according to claim 1, wherein the substrate has an average thickness of 3.8 μm or less.

12. The magnetic recording medium according to claim 1, wherein the substrate has an average thickness of 3.4 μm or less.

13. The magnetic recording medium according to claim 1, wherein the magnetic layer has an average thickness of 80 nm or less.

14. The magnetic recording medium according to claim 1, wherein the magnetic layer has an average thickness of 70 nm or less.

15. The magnetic recording medium according to claim 1, wherein the magnetic layer has an average thickness of 50 nm or less.

16. The magnetic recording medium according to claim 1, wherein the underlayer has an average thickness of 0.3 μm or more and 1.0 μm or less.

17. The magnetic recording medium according to claim 1, having an average thickness of 5.0 μm or less.

18. The magnetic recording medium according to claim 1, having an average thickness of 4.4 μm or less.

19. The magnetic recording medium according to claim 1, wherein the magnetic layer in a perpendicular direction of the magnetic recording medium has a squareness ratio of 65% or more.

20. The magnetic recording medium according to claim 1, wherein the magnetic layer in a perpendicular direction of the magnetic recording medium has a squareness ratio of 70% or more.

21. The magnetic recording medium according to claim 1, wherein the magnetic layer in a perpendicular direction of the magnetic recording medium has a squareness ratio of 75% or more.

22. The magnetic recording medium according to claim 1, wherein the magnetic layer in a perpendicular direction of the magnetic recording medium has a squareness ratio of 80% or more.

23. The magnetic recording medium according to claim 1, wherein the magnetic layer in a perpendicular direction of the magnetic recording medium has a squareness ratio of 85% or more.

24. The magnetic recording medium according to claim 1, wherein the magnetic powder has an average particle volume of 500 nm³ or more and 2500 nm³ or less.

25. The magnetic recording medium according to claim 1, wherein the magnetic powder has an average particle volume of 500 nm³ or more and 1600 nm³ or less.

26. The magnetic recording medium according to claim 1, wherein the magnetic powder has an average particle volume of 500 nm³ or more and 1500 nm³ or less.

27. The magnetic recording medium according to claim 1, wherein the magnetic powder includes hexagonal ferrite, ε iron oxide, or Co-containing spinel ferrite.

28. The magnetic recording medium according to claim 1, wherein the magnetic layer has five or more servo bands.

29. The magnetic recording medium according to claim 1, wherein the magnetic layer has nine or more servo bands.

30. The magnetic recording medium according to claim 28, wherein a ratio of a total area of the five or more servo bands to an area of a surface of the magnetic layer is 4.0% or less.

31. The magnetic recording medium according to claim 28, wherein the servo band has a width of 95 μm or less.

32. The magnetic recording medium according to claim 1, wherein
the magnetic layer is configured to form a plurality of data tracks, and
the data track has a width of 2000 nm or less.

33. The magnetic recording medium according to claim 1, wherein the substrate includes a polyester.

34. A cartridge comprising the magnetic recording medium according to claim 1.

35. The cartridge according to claim 34, comprising one or two reels around which the magnetic recording medium is wound.
